(19) United States
(12) Patent Application Publication
(10) Pub. No.: US 2017/0309236 A1
(43) Pub. Date: Oct. 26, 2017

(54) DISPLAY DEVICE

(71) Applicant: Sharp Kabushiki Kaisha, Sakai City, Osaka (JP)

(72) Inventor: Ryohei KOIZUMI, Sakai City (JP)

(21) Appl. No.: 15/517,975

(22) PCT Filed: Jul. 29, 2015
(86) PCT No.: PCT/JP2015/071498

§ 371 Date: Apr. 10, 2017

(30) Foreign Application Priority Data
Oct. 14, 2014 (JP) 2014-209875

(51) Int. Cl. G09G 3/34; G02F 1/1335; G09G 3/36

(52) U.S. Cl. CPC G09G 3/3413; G09G 3/3607; G02F 1/133611; G02F 1/133605; G09G 2320/064; G09G 2360/16

(57) ABSTRACT

A liquid crystal display device 10 includes a liquid crystal panel 11, a backlight 12, and a drive circuit for driving the liquid crystal panel 11 and the backlight 12. A part of the backlight 12 disposed in back of the liquid crystal panel 11 is transparent. The drive circuit drives the backlight 12 based on backlight control information included in a part of a video signal V1 corresponding to a blanking period. The backlight control information may be included in a part of the video signal V1 corresponding to a video signal period. Similar configuration may be applied to a display device which does not have a function of showing a space behind a display screen transparently. With this, a display device which easily receives lighting control information is provided.

### TECHNICAL FIELD

The present invention relates to a display device, especially to a display device which controls a status of a backlight.

### BACKGROUND ART

In recent years, a display device having a function of showing a space behind a display screen transparently has been developed. Such a display device is called a transparent display, a see-through display, or the like. For example, there is a transparent display using a display panel including shutter elements, such as a liquid crystal panel. In such a transparent display, a part (including a backlight) that overlaps with a display area of the display panel is formed of a transparent material.

In the following, there will be considered a liquid crystal display device including a liquid crystal panel and a backlight, and having a normal mode in which the backlight is turned on and a transparent mode in which the backlight is turned off. Furthermore, an area in the display screen in which transparency of each pixel is sufficiently large is referred to as “transparent area”, and light incident from a back surface of the display screen is referred to as “environment light”. In the normal mode, light from the backlight and the environment light are incident from the back surface of the liquid crystal panel. Thus, a space behind the display screen can be seen transparently through a transparent area, in accordance with a ratio of an intensity of the light from the backlight and that of the environment light. Since the light from the backlight is white light, the transparent area is clouded by the light from the backlight. An image is displayed except for the transparent area. The display screen in the normal mode includes a part in which the image is displayed and a part in which the space behind the display screen can be seen in a clouded and transparent manner. Since the backlight is turned off in the transparent mode, the transparent area is not clouded by the light from the backlight. Therefore, the space behind the display screen can be seen transparently with a high transparency through the transparent area in the transparent mode.

Related to the present invention, Patent Document 1 discloses a display device which inserts contents identification information to a part of a video signal corresponding to a blanking period and performs a video processing in accordance with contents. Furthermore, Patent Document 2 discloses a video signal supplying device which composes a display image and a control image for controlling a turn-on pattern of a backlight and supplies the composed signal as a video signal to a display device having a single color backlight.

### PRIOR ART DOCUMENTS

### Patent Documents

[Patent Document 1] International Publication No. 2008/111257

[Patent Document 2] Japanese Laid-Open Patent

### SUMMARY OF THE INVENTION

### Problems to be Solved by the Invention

As for a liquid crystal display device which controls a status of a backlight, it is necessary to supply backlight control information from a signal source provided outside of the liquid crystal display device. For example, the backlight control information includes backlight turn-on information indicating whether the backlight is to be turned on. In this case, there is a problem how to supply the backlight control information to the liquid crystal display device.

For example, there is devised a method in which a backlight control signal is provided separately from the video signal and the backlight control information is supplied using the backlight control signal. However, this method has a problem that a number of signal lines between the signal source and the liquid crystal display device increases.

Similar problems occur in a liquid crystal display device including a front light in place of the backlight, another display device (display device other than the liquid crystal display device) including the backlight or the front light and having the function of showing the space behind the display screen transparently, and a display device including the backlight or the front light and not having the function of showing the space behind the display screen transparently.

Accordingly, an object of the present invention is to provide a display device which can easily receive lighting control information.

### Means for Solving the Problems

According to a first aspect of the present invention, there is provided a display device having a function of showing a space behind a display screen transparently, the device including: a display panel; a lighting unit configured to irradiate one surface of the display panel with light; and a drive circuit configured to drive the display panel and the lighting unit based on a video signal supplied from a signal source, wherein a part of the lighting unit that overlaps with a display area of the display panel is transparent, the video signal includes lighting control information, and the drive circuit is configured to drive the lighting unit based on the lighting control information included in the video signal.

According to a second aspect of the present invention, in the first aspect of the present invention, the lighting control information is included in a part of the video signal corresponding to a blanking period.

According to a third aspect of the present invention, in the first aspect of the present invention, the lighting control information is included in a part of the video signal corresponding to a video display period.

According to a fourth aspect of the present invention, in anyone of the first to third aspects of the present invention, the lighting control information includes lighting turn-on information indicating whether the lighting unit is to be turned on, and the drive circuit is configured to switch whether the lighting unit is turned on, based on the lighting turn-on information.

According to a fifth aspect of the present invention, in anyone of the first to third aspects of the present invention, the lighting control information includes lighting status change information indicating to change a status of the lighting unit, and the drive circuit is configured to change the status of the lighting unit from turn-on to turn-off or from turn-off to turn-on, based on the lighting status change information.

According to a sixth aspect of the present invention, in any one of the first to third aspects of the present invention, the lighting control information includes lighting brightness information indicating brightness of the lighting unit, and the drive circuit is configured to control the brightness of the lighting unit based on the lighting brightness information.

According to a seventh aspect of the present invention, in any one of the first to third aspects of the present invention, the display panel is a liquid crystal panel with a color filter, the lighting unit is a backlight configured to irradiate a back surface of the display panel with white light, a part of the video signal corresponding to a video display period includes video data for one frame, and the drive circuit is configured to drive the display panel based on the video data in each frame period.

According to an eighth aspect of the present invention, in any one of the first to third aspects of the present invention, the display panel is a liquid crystal panel without a color filter, the lighting unit is a backlight including plural kinds of light sources corresponding to different colors, a part of the video signal corresponding to a video display period includes video data for one field, and the drive circuit is configured to drive the display panel based on the video data in each field period and control one kind of the light source to turn on in each field period, the kind in accordance with the field period.

According to a ninth aspect of the present invention, in the eighth aspect of the present invention, the lighting control information includes lighting color information indicating a color of a field, and the drive circuit is configured to control one kind of the light source to turn on, the kind corresponding to the color indicated by the lighting color information.

According to a tenth aspect of the present invention, in the eighth aspect of the present invention, the lighting control information includes lighting brightness information indicating brightness of the plural kinds of the light sources, and the drive circuit is configured to control the brightness of the plural kinds of the light sources based on the lighting brightness information.

According to an eleventh aspect of the present invention, in the second aspect of the present invention, a position of the lighting control information is fixed in the part of the video signal corresponding to the blanking period.

According to a twelfth aspect of the present invention, in the second aspect of the present invention, a position of the lighting control information is not fixed in the part of the video signal corresponding to the blanking period, and the drive circuit is configured to search the lighting control information in the part of the video signal corresponding to the blanking period.

According to a thirteenth aspect of the present invention, in the third aspect of the present invention, the drive circuit is configured to drive the display panel using a fixed color data in place of video data which is missed from the video signal due to the lighting control information.

According to a fourteenth aspect of the present invention, in the third aspect of the present invention, the drive circuit is configured to drive the display panel using video data of a neighboring pixel in place of video data which is missed from the video signal due to the lighting control information.

According to a fifteenth aspect of the present invention, in any one of the first to third aspects of the present invention, the lighting unit is an edge light type backlight.

According to a sixteenth aspect of the present invention, in any one of the first to third aspects of the present invention, the lighting unit is a direct type backlight.

According to a seventeenth aspect of the present invention, in any one of the first to third aspects of the present invention, the display device further includes: an absorption type polarizing plate disposed in front of the display panel; and a reflection type polarizing plate disposed in back of the lighting unit, wherein the display panel is a liquid crystal panel, and the lighting unit is a backlight configured to emit light toward the reflection type polarizing plate.

According to an eighteenth aspect of the present invention, in any one of the first to third aspects of the present invention, the display device further includes: an absorption type polarizing plate; and a reflection type polarizing plate disposed in back of the display panel, wherein the display panel is a liquid crystal panel, the lighting unit is a front light configured to emit light toward a front surface of the display panel, and the absorption type polarizing plate is disposed in front of the lighting unit.

According to a nineteenth aspect of the present invention, in anyone of the first to third aspects of the present invention, the display device further includes: an absorption type polarizing plate disposed in front of the display panel; and a reflection type polarizing plate disposed in back of the display panel, wherein the display panel is a liquid crystal panel, and the lighting unit is a front light configured to emit light toward the absorption type polarizing plate.

According to a twentieth aspect of the present invention, in the nineteenth aspect of the present invention, the display device further includes a leakage-suppressing absorption type polarizing plate disposed in front of the lighting unit.

According to a twenty-first aspect of the present invention, there is provided a display device including: a display panel; a lighting unit configured to irradiate one surface of the display panel with light; and a drive circuit configured to drive the display panel and the lighting unit based on a video signal supplied from a signal source, wherein the lighting unit includes plural kinds of light sources corresponding to different colors, a plurality of the light sources provided for each kind, the video signal includes lighting control information indicating brightness of the light sources individually, and the drive circuit is configured to control the brightness of the light sources individually, based on the lighting control information included in the video signal.

According to a twenty-second aspect of the present invention, in the twenty-first aspect of the present invention, the lighting control information is included in a part of the video signal corresponding to a blanking period.

According to a twenty-third aspect of the present invention, in the twenty-first aspect of the present invention, the lighting control information is included in a part of the video signal corresponding to a video display period.

### Effects of the Invention

According to the first or third aspect of the present invention, since the lighting control information is included in the video signal, the lighting control information can be received easily. Furthermore, contents displayed in the display screen (especially, in a transparent area in the display screen) can be switched by controlling status, brightness, or the like of the lighting unit based on the lighting control information.

According to the second aspect of the present invention, since the lighting control information is included in the part of the video signal corresponding to the blanking period, the lighting control information can be received easily without reducing an amount of video data.

According to the fourth aspect of the present invention, it is possible to switch whether the lighting unit is to be turned on, based on the lighting turn-on information included in the video signal, especially based on the lighting turn-on information included in the part of the video signal corresponding to the blanking period or the video display period.

According to the fifth aspect of the present invention, it is possible to switch whether the lighting unit is to be turned on, based on the lighting status change information included in the video signal, especially based on the lighting status change information included in the part of the video signal corresponding to the blanking period or the video display period.

According to the sixth aspect of the present invention, the brightness of the lighting unit can be controlled based on the lighting brightness information included in the video signal, especially based on the lighting brightness information included in the part of the video signal corresponding to the blanking period or the video display period.

According to the seventh aspect of the present invention, in a color-filter type liquid crystal display device, it is possible to easily receive the lighting control information and switch the contents displayed in the display screen, based on the lighting control information.

According to the eighth aspect of the present invention, in a field-sequential type liquid crystal display device, it is possible to easily receive the lighting control information and switch the contents displayed in the display screen, based on the lighting control information.

According to the ninth aspect of the present invention, it is possible to control one kind of the light source to turn on, the kind corresponding to the color of the field, based the lighting color information included in the video signal, especially based on the lighting color information included in the part of the video signal corresponding to the blanking period or the video display period.

According to the tenth aspect of the present invention, it is possible to control the brightness of the plural kinds of the light sources included in the backlight, based on the lighting brightness information included in the video signal, especially based on the lighting brightness information included in the part of the video signal corresponding to the blanking period or the video display period.

According to the eleventh aspect of the present invention, the lighting control information can be obtained easily by fixing the position of the lighting control information.

According to the twelfth aspect of the present invention, even when the position of the lighting control information is not fixed, the lighting control information can be obtained by searching.

According to the thirteenth aspect of the present invention, a natural image can be displayed by displaying a pixel for which video data is not included in the video signal, with the fixed color.

According to the fourteenth aspect of the present invention, a natural image can be displayed by displaying a pixel for which video data is not included in the video signal, with the same color as the neighboring pixel.

According to the fifteenth aspect of the present invention, by using the edge light type backlight as the lighting unit, it is possible to make a part of the lighting unit transparent, the part overlapping with the display area of the display panel and show the space behind the display screen transparently.

According to the sixteenth aspect of the present invention, when the direct type backlight is used as the lighting unit, it is possible to show the space behind the display screen transparently, by making a part of the lighting unit transparent, the part overlapping with the display area of the display panel.

According to the seventeenth aspect of the present invention, in the liquid crystal display device including the absorption type polarizing plate, the liquid crystal panel, the backlight, and the reflection type polarizing plate, it is possible to easily receive the lighting control information and switch the contents displayed in the display screen, based on the lighting control information.

According to the eighteenth or nineteenth aspect of the present invention, in the liquid crystal display device including the absorption type polarizing plate, the front light, the liquid crystal panel, and the reflection type polarizing plate, it is possible to easily receive the lighting control information and switch the contents displayed in the display screen, based on the lighting control information.

According to the twentieth aspect of the present invention, it is possible to absorb a part of light leaked from the front light toward a front using the leakage-suppressing absorption type polarizing plate, and prevent image quality degradation due to leakage of the light from the front light.

According to the twenty-first or twenty-third aspect of the present invention, in the display device including the lighting unit having plural kinds of the light sources corresponding to the different colors, the plurality of light sources provided for each kind, since the lighting control information is included in the video signal, it is possible to easily receive the lighting control information which indicates the brightness of the plural kinds of the light sources individually. Furthermore, power consumption of the display device can be reduced by controlling the brightness of the light sources based on the lighting control information individually.

According to the twenty-second aspect of the present invention, since the lighting control information is included in the part of the video signal corresponding to the blanking period, the lighting control information can be received easily without reducing an amount of video data.

### BRIEF DESCRIPTION OF THE DRAWINGS

FIG. 1 is a block diagram showing a configuration of a liquid crystal display device according to a first embodiment of the present invention.

FIG. 2 is a diagram showing a configuration of a backlight of the liquid crystal display devices shown in FIG. 1.

FIG. 3 is a diagram showing a cross section of a display unit of the liquid crystal display device shown in FIG. 1.

FIG. 4 is a diagram showing an example of a display screen in a normal mode of the liquid crystal display device shown in FIG. 1.

FIG. 5 is a diagram showing an example of a display screen in a transparent mode of the liquid crystal display device shown in FIG. 1.

FIG. 6 is a diagram showing a format of a video signal of the liquid crystal display device shown in FIG. 1.

FIG. 7 is a diagram showing a format of a video signal of a liquid crystal display device according to a second embodiment of the present invention.

FIG. 8 is a diagram showing an example of change of a status of a backlight of the liquid crystal display device according to the second embodiment of the present invention.

FIG. 9 is a diagram showing a first example of a format of a video signal of a liquid crystal display device according to a third embodiment of the present invention.

FIG. 10 is a diagram showing a second example of the format of the video signal of the liquid crystal display device according to the third embodiment of the present invention.

FIG. 11 is a diagram showing a format of a video signal of a liquid crystal display device according to a fourth embodiment of the present invention.

FIG. 12 is a diagram for describing a first method in the liquid crystal display device according to the fourth embodiment of the present invention.

FIG. 13 is a diagram for describing a second method in the liquid crystal display device according to the fourth embodiment of the present invention.

FIG. 14 is a diagram showing a first example of a format of a video signal of a liquid crystal display device according to a fifth embodiment of the present invention.

FIG. 15 is a diagram showing a second example of the format of the video signal of the liquid crystal display device according to the fifth embodiment of the present invention.

FIG. 16 is a diagram showing a third example of the format of the video signal of the liquid crystal display device according to the fifth embodiment of the present invention.

FIG. 17 is a diagram showing a fourth example of the format of the video signal of the liquid crystal display device according to the fifth embodiment of the present invention.

FIG. 18 is a diagram showing a format of a video signal of a liquid crystal display device according to a sixth embodiment of the present invention.

FIG. 19 is a diagram showing a format of a video signal of a liquid crystal display device according to a seventh embodiment of the present invention.

FIG. 20 is a diagram showing a cross section of a display unit of a liquid crystal display device according to a variant of the first to seventh embodiments of the present invention.

FIG. 21 is a diagram showing a cross section of a display unit of a liquid crystal display device according to an eighth embodiment of the present invention.

FIG. 22 is a diagram showing how light proceeds in the liquid crystal display device according to the eighth embodiment of the present invention when a rotation angle is 0°.

FIG. 23 is a diagram showing how light proceeds in the liquid crystal display device according to the eighth embodiment of the present invention when the rotation angle is 90°.

FIG. 24 is a diagram showing a cross section of a display unit of a liquid crystal display device according to a variant of the eighth embodiment of the present invention.

FIG. 25 is a diagram showing a cross section of a display unit of a liquid crystal display device according to a variant of the eighth embodiment of the present invention.

FIG. 26 is a diagram showing a cross section of a display unit of a liquid crystal display device according to a variant of the eighth embodiment of the present invention.

FIG. 27 is a diagram showing a first example of a format of a video signal of a liquid crystal display device according to a ninth embodiment of the present invention.

FIG. 28 is a diagram showing a second example of the format of the video signal of the liquid crystal display device according to the ninth embodiment of the present invention.

FIG. 29 is a diagram showing a third example of the format of the video signal of the liquid crystal display device according to the ninth embodiment of the present invention.

FIG. 30 is a diagram showing a display screen of the liquid crystal display device according to the ninth embodiment of the present invention.

FIG. 31 is a diagram showing a first example of a format of a video signal of a liquid crystal display device according to a tenth embodiment of the present invention.

FIG. 32 is a diagram showing a second example of the format of the video signal of the liquid crystal display device according to the tenth embodiment of the present invention.

FIG. 33 is a diagram showing a third example of the format of the video signal of the liquid crystal display device according to the tenth embodiment of the present invention.

FIG. 34 is a diagram showing a first example of a display screen of a liquid crystal display device according to an eleventh embodiment of the present invention.

FIG. 35 is a diagram showing a second example of the display screen of the liquid crystal display device according to the eleventh embodiment of the present invention.

FIG. 36 is a diagram showing a third example of the display screen of the liquid crystal display device according to the eleventh embodiment of the present invention.

FIG. 37 is a diagram showing a configuration of a backlight of a liquid crystal display device according to a twelfth embodiment of the present invention.

FIG. 38 is a diagram showing a first example of a format of a video signal of the liquid crystal display device according to the twelfth embodiment of the present invention.

FIG. 39 is a diagram showing a second example of the format of the video signal of the liquid crystal display device according to the twelfth embodiment of the present invention.

### MODES FOR CARRYING OUT THE INVENTION

In the following, liquid crystal display devices according to first to twelfth embodiments of the present invention will be described referring to the drawings. The liquid crystal display devices according to the first to eleventh embodiments have a normal mode in which a backlight is turned on and a transparent mode in which the backlight is turned off. In the first to fourth embodiments, color-filter type liquid crystal display devices will be described. In the fifth to seventh embodiments, field-sequential type liquid crystal display devices will be described. In the eighth embodiment, a liquid crystal display device having a configuration different from those of the first to seventh embodiments will be described. In the ninth to eleventh embodiments, liquid crystal display devices which receive backlight control information in a manner different from those in the first to eighth embodiments will be described. In the twelfth embodiment, a display device which does not have the transparent mode will be described. In the following description, “transparent” means not only a transparent state in which an existence of elements can almost hardly be recognized, but also a state in which a space behind the elements can be seen transparently to some extent, although the existence of the elements can be recognized.

### First Embodiment

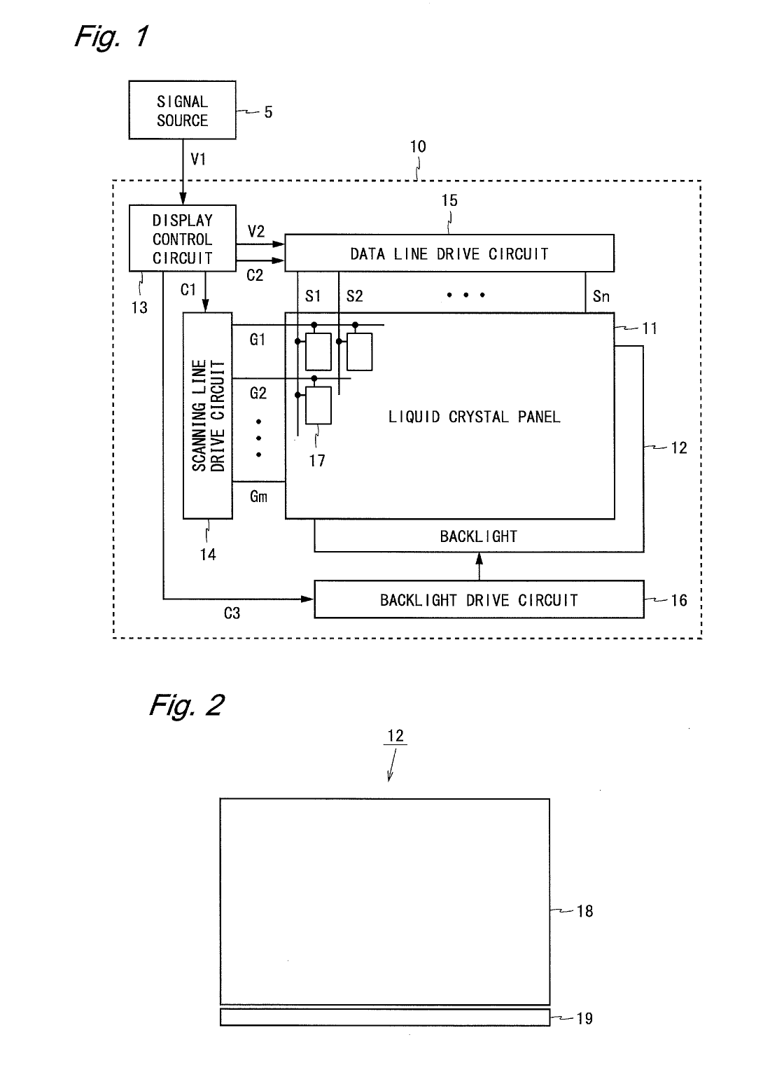

FIG. 1 is a block diagram showing a configuration of a liquid crystal display device according to a first embodiment of the present invention. A liquid crystal display device 10 shown in FIG. 1 is a color-filter type liquid crystal display device including a liquid crystal panel 11, a backlight 12, a display control circuit 13, a scanning line drive circuit 14, a data line drive circuit 15, and a backlight drive circuit 16. A signal source 5 which supplies a video signal V1 to the liquid crystal display device 10 is provided outside of the liquid crystal display device 10. The liquid crystal display device 10 displays a color image based on the video signal V1 supplied from the signal source 5.

The liquid crystal panel 11 includes m scanning lines G1 to Gm, n data lines S1 to Sn, and (m×n) pixel circuits 17. The scanning lines G1 to Gm extend in a horizontal direction of a display screen (lateral direction in FIG. 1) and are arranged in parallel to each other. The data lines S1 to Sn extend in a vertical direction (longitudinal direction in FIG. 1) and are arranged in parallel to each other so as to intersect with the scanning lines G1 to Gm perpendicularly. The scanning lines G1 to Gm and the data lines S1 to Sn intersect at (m×n) points. The (m×n) pixel circuits 17 are arranged in the neighborhoods of the intersections of the scanning lines G1 to Gm and the data line S1 to Sn, respectively. Three pixel circuits 17 arranged in an extending direction of the scanning lines G1 to Gm function as a red sub-pixel, a green sub-pixel, and a blue sub-pixel, respectively. These three pixel circuits 17 correspond to one color pixel. The (m×n) pixel circuits 17 included in the liquid crystal panel 11 correspond to (m×n/3) color pixels.

The backlight 12 irradiates a back surface of the liquid crystal panel 11 with white light. As shown in FIG. 2, the backlight 12 is an edge light type backlight including a light guide plate 18 and a light source 19. The light guide plate 18 is disposed in back of the liquid crystal panel 11, and the light source 19 is arranged along one side surface (lower side surface in FIG. 2) of the light guide plate 18. A CCFL (Cold

Cathode Fluorescent Lamp), LEDs (Light Emitting Diodes) of RGB three colors, or the like are used as the light source 19, for example. The light guide plate 18 is formed of a transparent material. A part of the backlight 12 that overlaps with a display area of the liquid crystal panel 11 is transparent.

Note that although the light source 19 is arranged along one side surface of the light guide plate 18 in FIG. 2, the light source 19 may be arranged along a plurality of side surfaces of the light guide plate 18. The backlight 12 functions as a lighting unit configured to irradiate one surface of the liquid crystal panel 11 with light.

The signal source 5 supplies the video signal V1 to the liquid crystal display device 10 in each frame period. The video signal V1 supplied to the liquid crystal display device 10 is input to the display control circuit 13. Based on the video signal V1, the display control circuit 13 outputs control signals C1 to C3 to the scanning line drive circuit 14, the data line drive circuit 15, and the backlight drive circuit 16, respectively, and outputs a video signal V2 to the data line drive circuit 15. The control signal C1 includes a gate start pulse and a gate clock, for example. The control signal C2 includes a source start pulse and a source clock, for example. The control signal C3 indicates a status of the backlight 12 for each frame period.

The scanning line drive circuit 14 drives the scanning lines G1 to Gm based on the control signal C1. More specifically, the scanning line drive circuit 14 sequentially selects one scanning line from among the scanning lines G1 to Gm based on the control signal C1, and applies a selection voltage (a high level voltage, for example) to the selected scanning line for one line period. With this, n pixel circuits 17 connected to the selected scanning line are selected collectively. The data line drive circuit 15 drives the data lines S1 to Sn based on the control signal C2 and the video signal V2. More specifically, the data line drive circuit 15 applies n data voltages in accordance with the video signal V2 to the data lines S1 to Sn for one line period. With this, the n data voltages in accordance with the video signal V2 are written to the n pixel circuits 17 connected to the selected scanning lines, respectively. The backlight drive circuit 16 controls the backlight 12 to turn on or turn off, in accordance with the control signal C3. When the value of the control signal C3 is 1, the backlight 12 is turned on. When the value of the control signal C3 is 0, the backlight 12 is turned off. The scanning line drive circuit 14, the data line drive circuit 15, and the backlight drive circuit 16 function as a drive circuit configured to drive the liquid crystal panel 11 and the backlight 12.

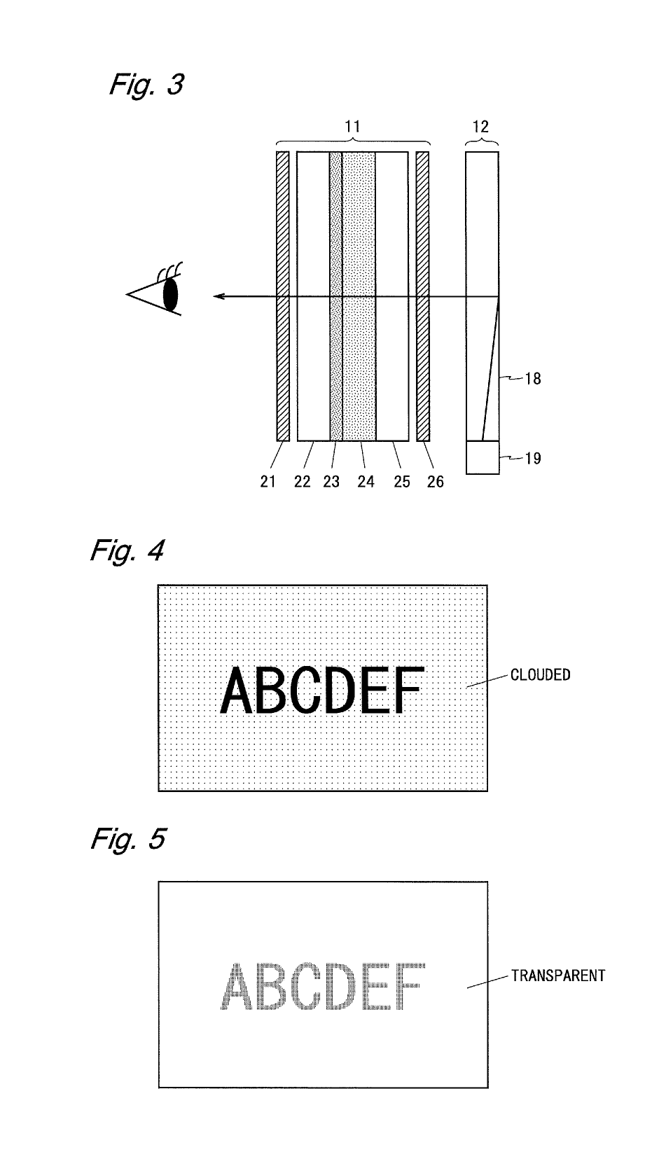

FIG. 3 is a diagram showing a cross section of a display unit of the liquid crystal display device 10. As shown in FIG. 3, the liquid crystal panel 11 has a configuration in which liquid crystal 24 is sandwiched between two glass substrates 22, 25. The scanning lines, the data lines, and the pixel circuits are formed on one surface (left-side surface in FIG. 3) of the glass substrate 25. A polarizing plate 26 is provided to the other surface of the glass substrate 25. A color filter 23 and a common electrode (not shown) are formed on one surface (right-side surface in FIG. 3) of the glass substrate 22. A polarizing plate 21 is provided to the other surface of the glass substrate 22.

The liquid crystal display device 10 has a normal mode and a transparent mode. In the normal mode, the backlight 12 is turned on, and the liquid crystal display device 10 performs color display. When a transparent area (area having a sufficiently large transparency) is included in a display screen, the transparent area is clouded by light from the backlight in the normal mode. In the transparent mode, the backlight 12 is turned off. When the transparent area is included in the display screen, a space behind the display screen can be seen transparently through the transparent area in the transparent mode. Switching between the normal mode and the transparent mode is performed based on backlight control information included in the video signal V1.

FIG. 4 is a diagram showing an example of a display screen in the normal mode. FIG. 5 is a diagram showing an example of a display screen in the transparent mode. It is assumed in FIGS. 4 and 5 that a surrounding part of a character string is included in a transparent area. In the display screen shown in FIG. 4 (in the normal mode), characters are displayed using a designated color, and the space behind the display screen can be seen in a clouded and transparent manner through the transparent area. In the display screen shown in FIG. 5 (in the transparent mode), the characters are displayed using a color lighter than the specified color, and the space behind the display screen can be seen transparently through the transparent area with a higher transparency.

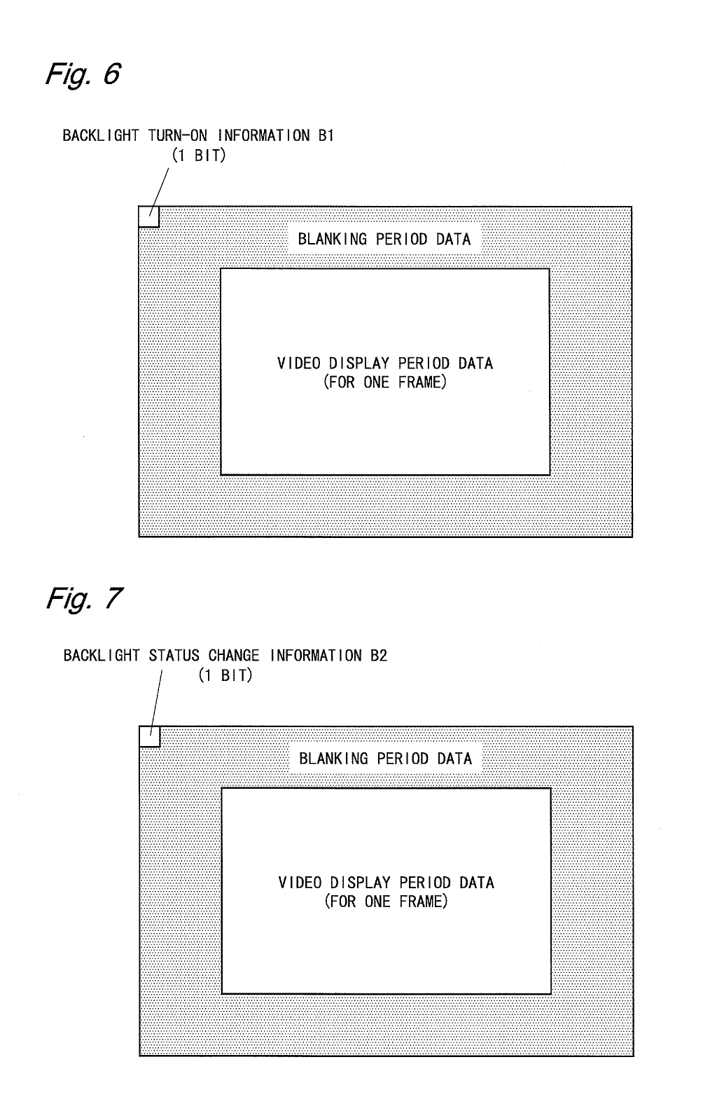

FIG. 6 is a diagram showing a format of the video signal V1 according to the present embodiment. FIG. 6 describes a format of the video signal V1 supplied from the signal source 5 to the liquid crystal display device 10 in one frame period.

In the liquid crystal display device 10, one frame period is divided into a video display period and a blanking period. Correspondingly, the video signal V1 for one frame period has a part corresponding to the video display period and a part corresponding to the blanking period (the former is depicted as “video display period data”, and the latter is depicted as “blanking period data” in the drawings). The part of the video signal corresponding to the video display period includes (m×n/3) pieces of red video data, (m×n/3) pieces of green video data, and (m×n/3) pieces of blue video data corresponding to the (m×n) pixel circuits 17.

The part of the video signal V1 corresponding to the blanking period includes, as the backlight control information, backlight turn-on information B1 having one bit. The backlight turn-on information B1 having the value 1 indicates that the backlight 12 is to be turned on. The backlight turn-on information B1 having the value 0 indicates that the backlight 12 is to be turned off. The position of the backlight turn-on information B1 is fixed in the part corresponding to the blanking period.

The display control circuit 13 extracts the backlight turn-on information B1 from the video signal V1 for one frame period received from the signal source 5, and outputs the extracted backlight turn-on information B1 as the control signal C3. When the value of the control signal C3 (value of the backlight turn-on information B1) is 1, the backlight drive circuit 16 controls the backlight 12 to turn on. At this time, the liquid crystal display device 10 operates in the normal mode. When the value of the control signal C3 is 0, the backlight drive circuit 16 controls the backlight 12 to turn off. At this time, the liquid crystal display device 10 operates in the transparent mode.

In the liquid crystal display device 10, the transparent area is clouded by light from the backlight in the normal mode. In the transparent mode, since the backlight 12 is turned off, the liquid crystal display device 10 cannot perform clear color display. However, since the transparent area is not clouded, the transparency of the transparent area becomes high.

Hereinafter, effects of the liquid crystal display device 10 according to the present embodiment will be described.

In the liquid crystal display device 10 according to the present embodiment, the backlight turn-on information B1 is included in a part of the video signal V1 corresponding to the blanking period. Therefore, according to the liquid crystal display device 10 of the present embodiment, the backlight turn-on information B1 can be received easily without reducing an amount of video data. Furthermore, it is possible to switch between the normal mode and the transparent mode, by controlling the backlight 12 to turn on or turn off based on the received backlight turn-on information B1.

As shown above, the liquid crystal display device 10 according to the present embodiment includes a display panel (liquid crystal panel 11), a lighting unit (backlight 12) for irradiating one surface (back surface) of the display panel with light, and a drive circuit (scanning line drive circuit 14, data line drive circuit 15, and backlight drive circuit 16) for driving the display panel and the lighting unit based on the video signal V1 supplied from the signal source 5. A part of the lighting unit that overlaps with a display area of the display panel is transparent. The video signal V1 includes lighting control information (backlight turn-on information B1 as backlight control information). The drive circuit drives the lighting unit based on the lighting control information included in the video signal V1. The lighting control information is included in a part of the video signal V1 corresponding to the blanking period.

According to the liquid crystal display device 10 of the present embodiment, since the lighting control information is included in the video signal V1, the lighting control information can be received easily. Furthermore, contents shown in the display screen (especially, in transparent area in the display screen) can be changed by controlling the status of the lighting unit based on the lighting control information. Furthermore, since the lighting control information is included in the part of the video signal V1 corresponding to the blanking period, the lighting control information can be received easily without reducing an amount of video data.

Furthermore, the lighting control information includes lighting turn-on information (backlight turn-on information B1) indicating whether the lighting unit is to be turned on, and the drive circuit switches whether the lighting unit is to be turned on, based on the lighting turn-on information. Therefore, it is possible to switch whether the lighting unit is turned on, based on the lighting turn-on information included in the part of the video signal V1 corresponding to the blanking period. Furthermore, the lighting control information can be obtained easily by fixing the position of the lighting control information in the part of the video signal V1 corresponding to the blanking period.

Furthermore, the display panel is the liquid crystal panel 11 with the color filter 23, the lighting unit is a backlight for irradiating the back surface of the display panel with white light, the part of the video signal V1 corresponding to the video display period includes the video data corresponding to one frame, and the drive circuit drives the display panel based on the video data in each frame period. Therefore, in the color-filter type liquid crystal display device 10, it is possible to easily receive the lighting control information without reducing the amount of the video data, and switch the contents displayed in the display screen, based on the lighting control information. Furthermore, by using the edge light type backlight 12 as the lighting unit, it is possible to make a part of the lighting unit transparent, the part overlapping with the display area of the display panel and show a space behind the display screen transparently.

### Second Embodiment

Liquid crystal display devices according to second to fourth embodiments of the present invention have the same configuration as the liquid crystal display device according to the first embodiment. In the liquid crystal display device according to the second embodiment, backlight control information which is different from that of the first embodiment is included in a part of the video signal V1 corresponding to the blanking period. Differences from the first embodiment will be described below.

FIG. 7 is a diagram showing a format of the video signal V1 according to the present embodiment. In the present embodiment, the part of the video signal V1 corresponding to the blanking period includes, as the backlight control information, backlight status change information B2 having one bit. However, in some cases, the backlight status change information B2 is included in the video signal V1 for one frame period, and the information B2 is not included therein in other cases. The value of the backlight status change information B2 is fixed to 1. The backlight status change information B2 having the value 1 indicates that the status of the backlight 12 is to be changed from turn-on to turn-off or from turn-off to turn-on. The position of the backlight status change information B2 is fixed in the part of the video signal V1 corresponding to the blanking period.

The display control circuit 13 checks whether the backlight status change information B2 is included in the video signal V1 for one frame period received from the signal source 5. When the backlight status change information B2 is not included, the display control circuit 13 outputs the control signal C3 having the same value as a previous value. When the backlight status change information B2 is included, the display control circuit 13 outputs the control signal C3 having the value which is different from the previous value (control signal C3 having a value 1 when the previous value is 0, and having a value 0 when the previous value is 1). When the value of the control signal C3 is 1, the backlight drive circuit 16 controls the backlight 12 to turn on. When the value of the control signal C3 is 0, the backlight drive circuit 16 controls the backlight 12 to turn off. In this way, the backlight drive circuit 16 switches the status of the backlight 12 from turn-on to turn-off or from turn-off to turn-on, based on the backlight status change information B2.

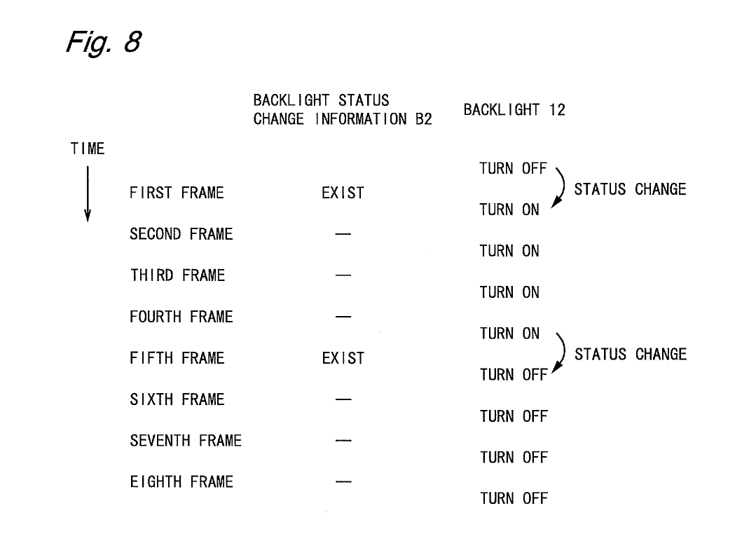

FIG. 8 is a diagram showing an example of status change of the backlight 12. In the example shown in FIG. 8, the backlight 12 is turned off in an initial state. Since the backlight status change information B2 is included in the video signal V1 for a first frame, the backlight drive circuit 16 switches the status of the backlight 12 from turn-off to turn-on. Thus, the backlight 12 is turned on in the first frame period. Since the backlight status change information B2 is not included in the video signal V1 for second to fourth frames, the backlight drive circuit 16 does not switch the status of the backlight 12. Thus, the backlight 12 continues to be turned on from the second to fourth frame periods. Since the backlight status change information B2 is included in the video signal V1 for a fifth frame, the backlight drive circuit 16 switches the status of the backlight 12 from turn-on to turn-off. Thus, the backlight 12 is turned off in the fifth frame period. Since the backlight status change information B2 is not included in the video signal V1 for sixth to eighth frames, the backlight drive circuit 16 does not switch the status of the backlight 12. Thus, the backlight 12 continues to be turned off from the sixth to eighth frame periods.

As shown above, in the liquid crystal display device according to the present embodiment, lighting control information (backlight control information) includes lighting status change information (backlight status change information B2) indicating to switch the status of a lighting unit (backlight 12), and a drive circuit changes the status of the lighting unit from turn-on to turn-off or from turn-off to turn-on, based on the lighting status change information. Therefore, according to the liquid crystal display device of the present embodiment, it is possible to switch whether the lighting unit is turned on, based on the lighting status change information included in the part of the video signal V1 corresponding to the blanking period, and attain the same effects as those attained by the first embodiment.

### Third Embodiment

In a liquid crystal display device according to a third embodiment of the present invention, backlight control information is included in a position which if different from those in the first and second embodiments. Differences from the first and second embodiments will be described below.

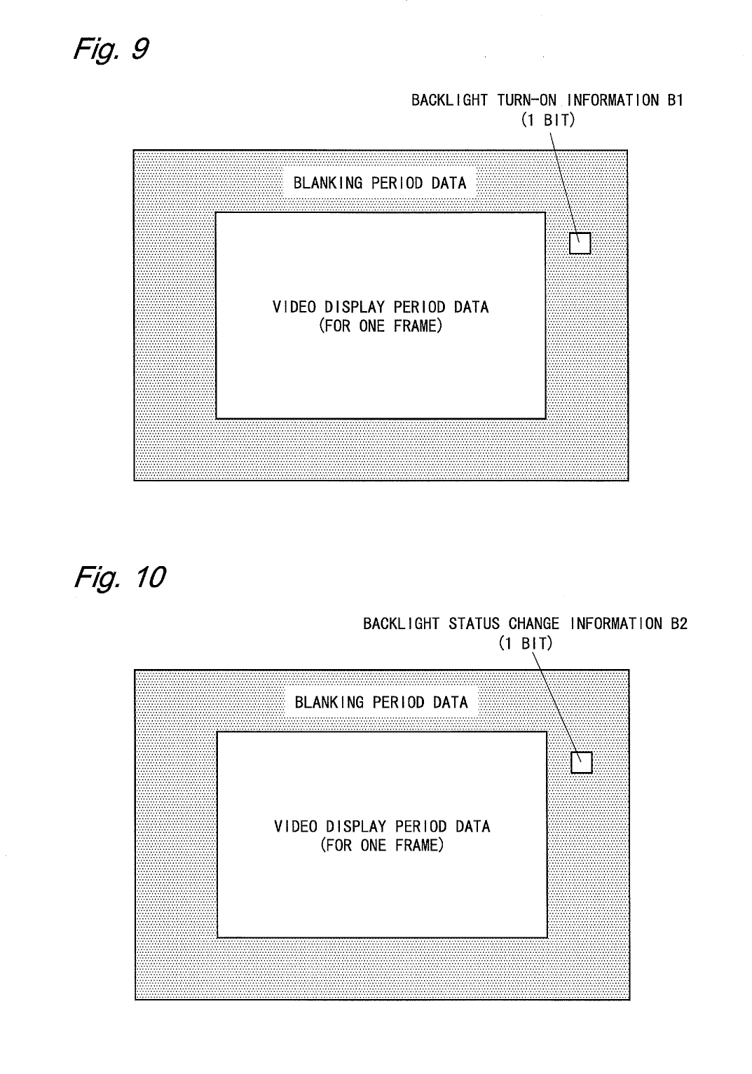

FIG. 9 is a diagram showing a first example of a format of the video signal V1 according to the present embodiment. In FIG. 9, backlight turn-on information B1 having one bit is included in a part of the video signal V1 corresponding to the blanking period. The position of the backlight turn-on information B1 is different from that in the first embodiment.

The display control circuit 13 knows the position of the backlight turn-on information B1. The display control circuit 13 can easily extract the backlight turn-on information B1 from the video signal V1.

FIG. 10 is a diagram showing a format of a second example of the video signal V1 according to the present embodiment. In FIG. 10, backlight status change information B2 having one bit is included in a part of the video signal V1 corresponding to the blanking period. The position of the backlight status change information B2 is different from that in the second embodiment. The display control circuit 13 knows the position of the backlight status change information B2. The display control circuit 13 can easily extract the backlight status change information B2 from the video signal V1.

According to the liquid crystal display device of the present embodiment, the same effects as those attained by the first and second embodiments can be attained. Note that in the second example, the position of the backlight status change information B2 may not be fixed in the part of the video signal V1 corresponding to the blanking period. Even when the display control circuit 13 does not know the position of the backlight status change information B2, it is possible to obtain the backlight status change information B2 by searching information having the value 1 in the part of the video signal V1 corresponding to the blanking period.

### Fourth Embodiment

In a liquid crystal display device according to a fourth embodiment of the present invention, backlight control information which is different from those of the first and second embodiments is included in a part of the video signal V1 corresponding to the blanking period. Differences from the first and second embodiments will be described below.

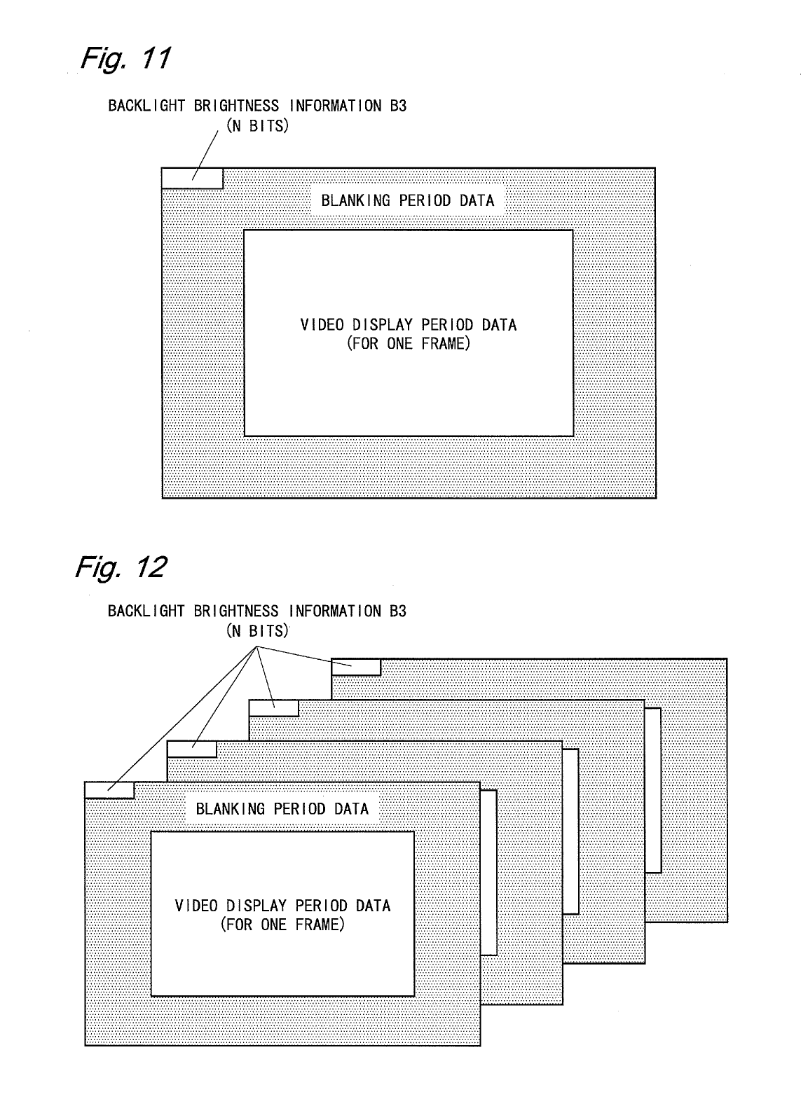

FIG. 11 is a diagram showing a format of the video signal V1 according to the present embodiment. In the present embodiment, backlight brightness information B3 having N bits (N is an integer not less than 2) is included in a part of the video signal V1 corresponding to the blanking period, as the backlight control information. The backlight brightness information B3 represents brightness of the backlight 12 in 2^{N} levels. For example, when N=8, the backlight brightness information B3 represents the brightness of the backlight 12 by a level in a range from 0 to 255. The position of the backlight brightness information B3 is fixed in the part of the video signal V1 corresponding to the blanking period.

The brightness of the backlight 12 is controlled, for example, by a method of controlling an amount of current supplied to the backlight 12, or a method of PWM (Pluse Width Modulation) controlling an voltage supplied to the backlight 12, and so on.

As for the present embodiment, following first and second methods are considered. FIG. 12 is a diagram for describing the first method. In the first method, in the video signal V1 of all frame periods, the backlight brightness information B3 is included in the part corresponding to the blanking period. The display control circuit 13 extracts the backlight brightness information B3 from the video signal V1 for one frame period received from the signal source 5, and outputs the extracted backlight brightness information B3 as the control signal C3. The backlight drive circuit 16 controls the brightness of the backlight 12 based on the control signal C3.

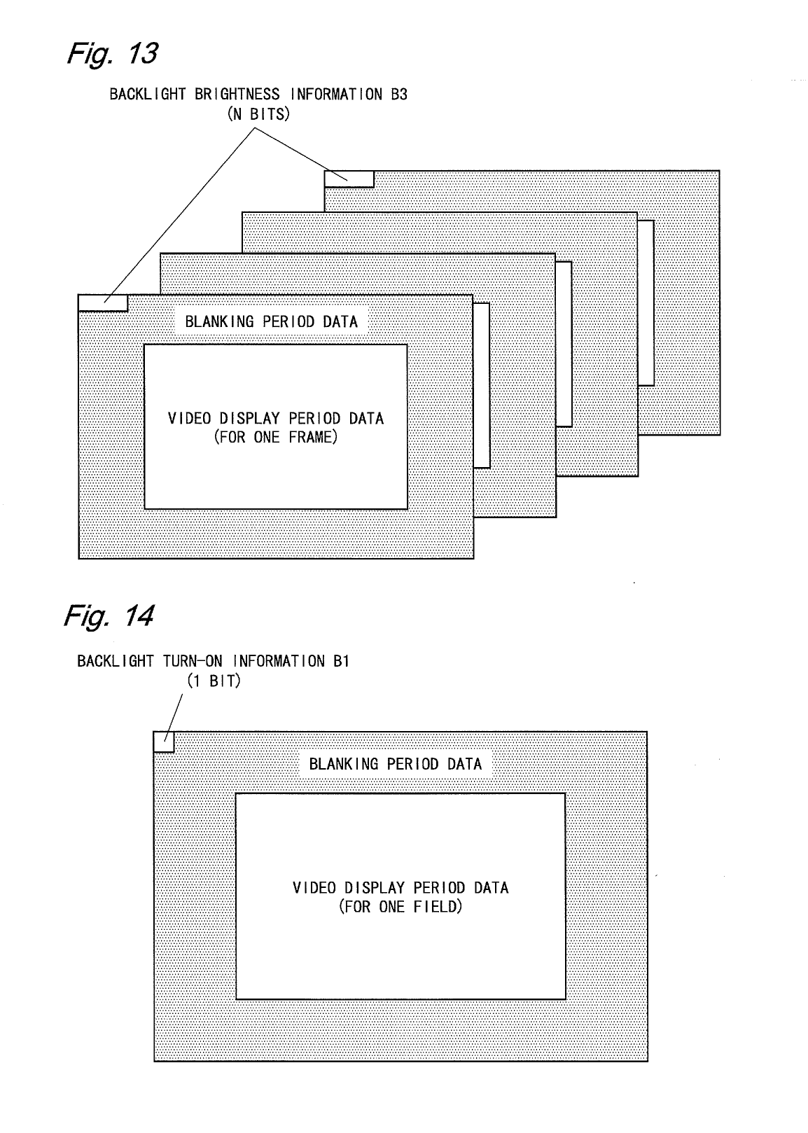

FIG. 13 is a diagram for describing the second method. In the second method, in some cases, the backlight brightness information B3 is included in a part of the video signal V1 for one frame period corresponding to the blanking period, and the backlight brightness information B3 is not included therein in other cases. The display control circuit 13 checks whether the backlight brightness information B3 is included in the video signal V1 for one frame period received from the signal source 5. When the backlight brightness information B3 is included, the display control circuit 13 outputs the extracted backlight brightness information B3 as the control signal C3. When the backlight brightness information B3 is not included, the display control circuit 13 outputs the control signal C3 having the same value as the previous value. The backlight drive circuit 16 controls the brightness of the backlight 12 based on the control signal C3.

According to the liquid crystal display device of the present embodiment, it is possible to change between the transparent mode and the normal mode and realize an operation mode between the transparent mode and the normal mode, by controlling the brightness of the backlight 12 based on the backlight brightness information B3.

As with the third embodiment, the backlight brightness information B3 may be included in a position which is different from those in FIGS. 12 and 13. In the first method, the display control circuit 13 knows the position of the backlight brightness information B3. The display control circuit 13 easily extracts the backlight brightness information B3 from the video signal V1. In the second method, the display control circuit 13 may know or may not know the position of the backlight brightness information B3. However, in the latter case, the backlight control information needs to include the backlight brightness information B3 and a flag information having one bit indicating an existence of the backlight brightness information B3. By using the flag information, it is possible for the display control circuit 13 to distinguish a case where the backlight brightness information B3 having a value 0 is included and a case where the backlight brightness information B3 is not included.

As shown above, in the liquid crystal display device according to the present embodiment, the lighting control information (backlight control information) includes the lighting brightness information (backlight brightness information B3) indicating the brightness of the lighting unit (backlight 12), and the drive circuit controls the brightness of the lighting unit based on the lighting brightness information. Therefore, the brightness of the lighting unit can be controlled based on the lighting brightness information included in the part of the video signal V1 corresponding to the blanking period, and attain the same effects as those attained by the first embodiment.

### Fifth Embodiment

A liquid crystal display device according to a fifth embodiment of the present invention has the same configuration as the liquid crystal display device according to the first embodiment. The liquid crystal display device according to the present embodiment is a field-sequential type liquid crystal display device. Differences from the first embodiment will be described below.

The signal source 5 supplies the video signal V1 to the liquid crystal display device 10 in each field period. The liquid crystal panel 11 does not have the color filter 23. In the liquid crystal panel 11, one pixel circuit 17 corresponds to one color pixel. The (m×n) pixel circuits 17 included in the liquid crystal panel 11 correspond to (m×n) color pixels.

The backlight 12 is an edge light type backlight including light sources of plural kinds corresponding to different colors. The backlight 12 includes, as the light sources 19, a red light source, a green light source, and a blue light source (for example, light emitting diodes of RGB three colors).

In the liquid crystal display device according to the present embodiment, one frame period is divided into first to third field periods. The video signal V1 for the first to third field periods includes red video data, green video data, and blue video data, respectively. In the first field period, the scanning line drive circuit 14 and the data line drive circuit 15 drive the liquid crystal panel 11 based on the red video data, and the backlight drive circuit 16 controls the red light source included in the backlight 12 to emit light. With this, a red field is displayed. In a similar manner, a green field is displayed in the second field period, and a blue field is displayed in the third field period. Three fields displayed in a time division manner are synthesized on retinas of an observer by an after image phenomenon, and are recognized as one color image by the observer.

In this manner, in the liquid crystal display device according to the present embodiment, the part of the video signal V1 corresponding to the video display period includes the video data for one field. The scanning line drive circuit 14 and the data line drive circuit 15 drive the liquid crystal panel 11 based on the video data in each field period. The backlight drive circuit 16 controls the light source in accordance with the field period to turn on in each field period among the three kinds of the light sources included in the backlight 12.

In the liquid crystal display device according to the present embodiment, since the liquid crystal panel 11 does not have the color filter 23, the transparency of the liquid crystal panel 11 is high. Therefore, according to the liquid crystal display device of the present embodiment, the transparency of the transparent area in the transparent mode can be made higher than that of a color-filter type liquid crystal display device.

FIG. 14 is a diagram showing a first example of a format of the video signal V1 according to the present embodiment. FIG. 14 describes the format of the video signal V1 supplied from the signal source 5 to the liquid crystal display device 10 in one field period. In the present embodiment, one field period is divided into a video display period and a blanking period. Correspondingly, the video signal V1 for one field period has a part corresponding to the video display period and a part corresponding to the blanking period. In the part of the video signal corresponding to the video display period, one of (m×n) pieces of red video data, (m×n) pieces of green video data, and (m×n) pieces of blue video data is included corresponding to the (m×n) pixel circuits 17.

As with the first embodiment, backlight turn-on information B1 having one bit is included in the part of the video signal V1 corresponding to the blanking period. The position of the backlight turn-on information B1 is fixed in the part of the video signal V1 corresponding to the blanking period. According to the liquid crystal display device of the first example, it is possible to switch between the normal mode and the transparent mode in each field period by switching whether the backlight 12 is turned on, based on the backlight turn-on information B1.

FIG. 15 is a diagram showing a second example of the format of the video signal V1 according to the present embodiment. In the second example, as with the second embodiment, backlight status change information B2 having one bit is included in the part of the video signal V1 corresponding to the blanking period. However, in some cases, the backlight status change information B2 is included in the video signal V1 for one field period, and the backlight status change information B2 is not included therein in other cases. The position of the backlight status change information B2 is fixed in the part of the video signal

V1 corresponding to the blanking period. Also according to the liquid crystal display device of the second example, it is possible to switch between the normal mode and the transparent mode in each field period by changing the backlight status change information B2 from turn-on to turn-off or from turn-off to turn-on based on the status of the backlight 12. Note that in the first and the second examples, the backlight control information may be included in a position which is different from those in FIGS. 14 and 15. Furthermore, in the first and second examples, when the color of the field is specified by the signal source 5, backlight color information indicating a color of a field may be transferred separately from the backlight turn-on information B1 or the backlight status change information B2. For example, the backlight color information may be transferred in a part of the video signal corresponding to the video display period.

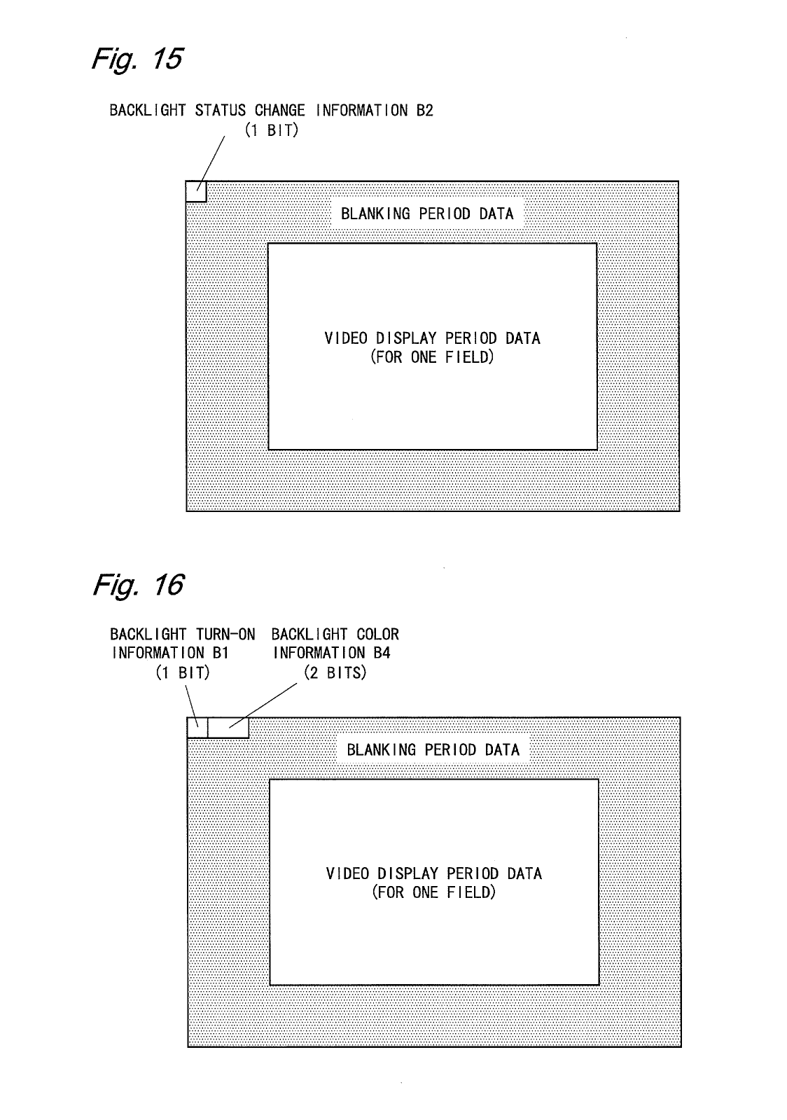

FIG. 16 is a diagram showing a third example of the format of the video signal V1 according to the present embodiment. In the third example, backlight turn-on information B1 having one bit and backlight color information B4 having two bits are included in the part of the video signal V1 for one field period corresponding to the blanking period, as the backlight control information. The backlight color information B4 represents the color of the field. The backlight color information B4 takes a value in a range from 0 to 2, corresponding to three fields. The backlight color information B4 having the values 0 to 2 represents red, green, and blue, respectively. The position of the backlight turn-on information B1 and the backlight color information B4 are fixed in the part of the video signal V1 corresponding to the blanking period.

The display control circuit 13 extracts the backlight turn-on information B1 and the backlight color information B4 from the video signal for one field period received from the signal source 5. When the value of the backlight turn-on information B1 is 1 and the value of the backlight color information B4 is 0, the display control circuit 13 outputs the control signal C3 for turning on the red light source included in the backlight 12. When the value of the backlight turn-on information B1 is 1 and the value of the backlight color information B4 is 1, the display control circuit 13 outputs the control signal C3 for turning on the green light source included in the backlight 12. When the value of the backlight turn-on information B1 is 1 and the value of the backlight color information B4 is 2, the display control circuit 13 outputs the control signal C3 for turning on the blue light source included in the backlight 12. When the value of the backlight turn-on information B1 is 0, the display control circuit 13 outputs the control signal C3 for turning off the red light source, the green light source, and the blue light source included in the backlight 12. The backlight drive circuit 16 drives the red light source, the green light source, and the blue light source included in the backlight 12, based on the control signal C3. The status of the backlight 12 is one of turn-on red, turn-on green, turn-on blue, and turn-off in accordance with the control signal C3.

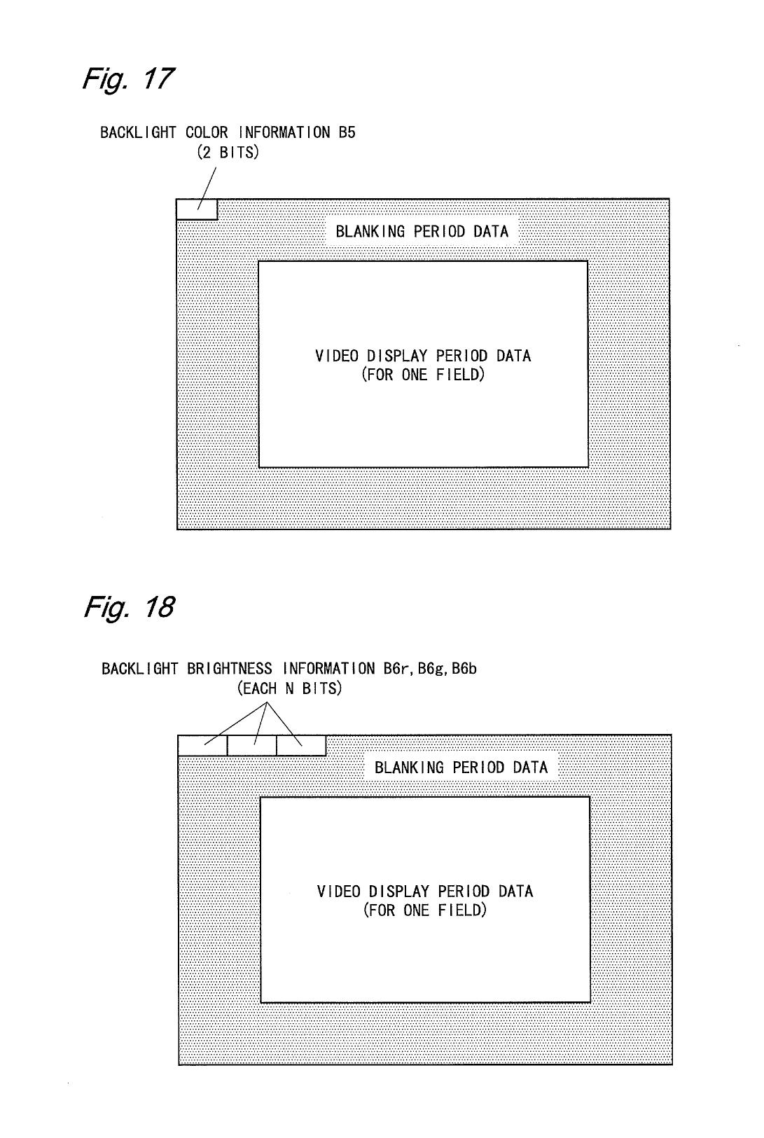

FIG. 17 is a diagram showing a fourth example of the format of the video signal V1 according to the present embodiment. In the fourth example, backlight color information B5 having two bits is included in the part of the video signal V1 for one field period corresponding to the blanking period, as the backlight control information. In the fourth example, the backlight color information B5 takes a value in a range from 0 to 3. The backlight color information B5 having the values 0 to 3 represents red, green, blue, and turn off, respectively.

The display control circuit 13 extracts the backlight color information B5 from the video signal V1 for one field period received from the signal source 5. When the value of the backlight color information B5 is 0, the display control circuit 13 outputs the control signal C3 for turning on the red light source included in the backlight 12. When the value of the backlight color information B5 is 1, the display control circuit 13 outputs the control signal C3 for turning on the green light source included in the backlight 12. When the value of the backlight color information B5 is 2, the display control circuit 13 outputs the control signal C3 for turning on the blue light source included in the backlight 12. When the value of the backlight color information B5 is 3, the display control circuit 13 outputs the control signal C3 for turning off the red light source, the green light source, and the blue light source included in the backlight 12. The backlight drive circuit 16 drives the red light source, the green light source, and the blue light source included in the backlight 12, based on the control signal C3. The status of the backlight 12 becomes one of turn-on red, turn-on green, turn-on blue, and turn-off, in accordance with the control signal C3.

According to the liquid crystal display devices of the third and fourth examples, it is possible to switch between the normal mode and the transparent mode in each field period using the backlight color information B5, and switch a light emission color of the backlight 12.

As shown above, in the liquid crystal display device according to the present embodiment, the display panel is the liquid crystal panel 11 without a color filter, the lighting unit is the backlight 12 including plural kinds of the light sources 19 corresponding to different colors, the part of the video signal V1 corresponding to the video display period includes the video data for one field, and a drive circuit (scanning line drive circuit 14, data line drive circuit 15, and backlight drive circuit 16) drives the display panel based on the video data in each field period and controls one kind of the light source 19 to turn on in each field, the kind corresponding to the field period. Therefore, in the field-sequential type liquid crystal display device, it is possible to easily receive the lighting control information (backlight control information) without reducing an amount of the video data, and switch the contents displayed in the display screen based on the lighting control information.

Furthermore, in the third and fourth examples, the lighting control information includes lighting color information (backlight color information B5) indicating the color of the field, and the drive circuit controls one kind of the light source 19 to turn on, the kind corresponding to the color indicated by the lighting color information B5. Therefore, it is possible to turn on the light source corresponding to the color of the field based on the lighting color information included in the part of the video signal V1 corresponding to the blanking period.

Although the backlight color information having two bits is used in the third and fourth examples, the number of bits of the backlight color information can be determined in accordance with the number of fields displayed in one frame period.

### Sixth Embodiment

Liquid crystal display devices according to sixth and seventh embodiments of the present invention have the same configuration as the liquid crystal display device according to the fifth embodiment. In the liquid crystal display device according to the sixth embodiment of the present invention, backlight control information which is different from that in the fifth embodiment is included in a part of the video signal V1 corresponding to the blanking period. Differences from the fifth embodiment will be described below.

FIG. 18 is a diagram showing a format of the video signal V1 according to the present embodiment. In the present embodiment, backlight brightness information B6r, B6g, B6b each having N bits are included in a part of the video signal V1 corresponding to the blanking period, as the backlight control information. The backlight brightness information B6r, B6g, B6b represent the brightness of the red light source, the green light source, and the blue light source included in the backlight 12, respectively, in 2^{N} levels. The position of the backlight brightness information B6r, B6g, B6b is fixed in the part of the video signal V1 corresponding to the blanking period.

The display control circuit 13 extracts the backlight brightness information B6r, B6g, B6b from the video signal V1 for one field period received from the signal source 5, and outputs the control signal C3 including the extracted backlight brightness information B6r, B6g, B6b. The backlight drive circuit 16 controls the brightness of the red light source included in the backlight 12 based on the backlight brightness information B6r included in the control signal C3. The backlight drive circuit 16 controls the brightness of the green light source and the blue light source included in the backlight 12 by a similar method. The red light source, the green light source and the blue light source included in the backlight 12 emit light at the brightness corresponding to the backlight brightness information B6r, B6g, B6b, respectively.

As shown above, in the liquid crystal display device according to the present embodiment, the lighting control information (backlight control information) includes the lighting brightness information (backlight brightness information B6r, B6g, B6b) indicating the brightness of the plural kinds of the light sources 19, and the drive circuit controls the brightness of the plurality kinds of the light sources (red light source, green light source, and blue light source) based on the lighting brightness information. Therefore, the brightness of the plurality kinds of the light sources included in the lighting unit (backlight 12) can be controlled based on the lighting brightness information included in the part of the video signal V1 corresponding to the blanking period. With this, light emission color of the lighting unit can be changed to an arbitrary intermediate color such as cyan, magenta, yellow.

### Seventh Embodiment

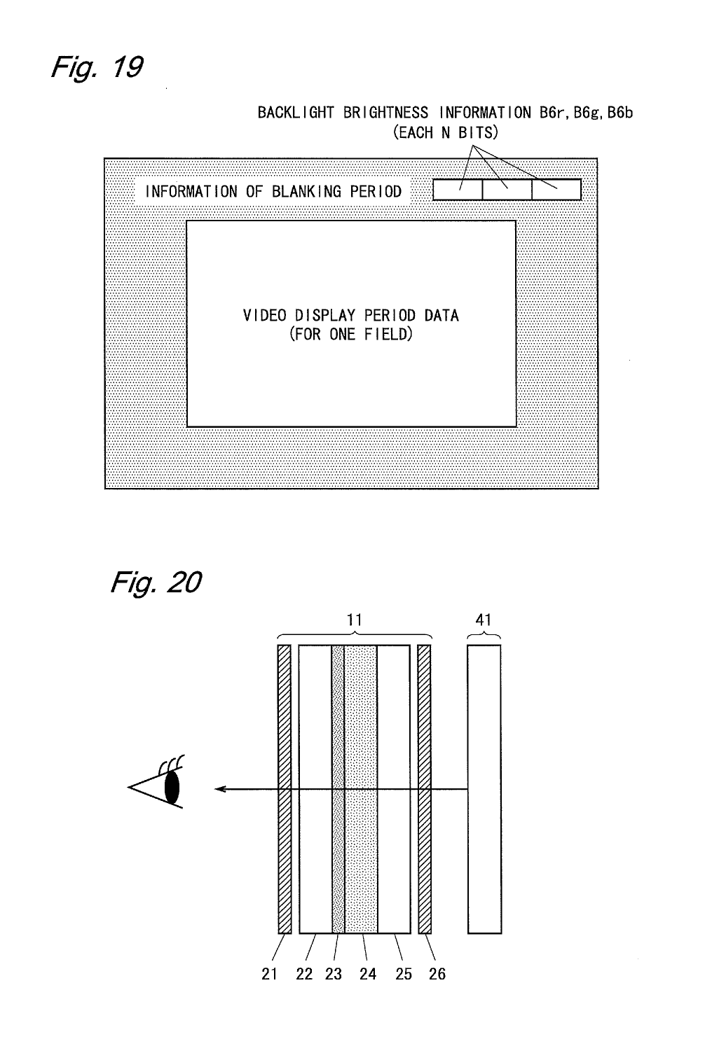

In the liquid crystal display device according to the present embodiment, the backlight control information is included in a position which is different from that in the sixth embodiment. Differences from the sixth embodiment will be described below. FIG. 19 is a diagram showing a format of the video signal V1 according to the present embodiment. In the present embodiment, backlight brightness information B6r, B6g, B6b each having N bits are included in a part of the video signal V1 corresponding to the blanking period. The position of the backlight brightness information B6r, B6g, B6b is different from that in the sixth embodiment. The display control circuit 13 knows the position of the backlight brightness information B6r, B6g, B6b. The display control circuit 13 can easily obtain the backlight brightness information B6r, B6g, B6b from the video signal V1.

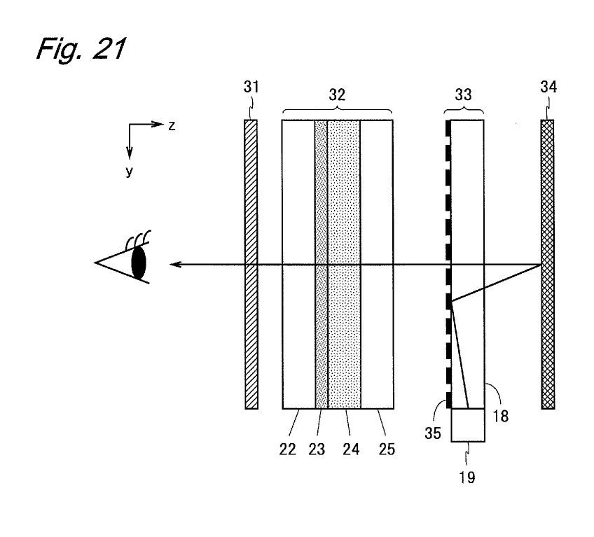

Note that as a variant of the first to seventh embodiments, a liquid crystal display device including a direct type backlight in place of the edge light type backlight 12 may be constituted. FIG. 20 is a diagram showing a cross section of a display unit of the liquid crystal display device according to the variant of the first to seventh embodiments of the present invention. In FIG. 20, a backlight 41 is a direct type backlight. A part of the backlight 41 that overlaps with the display area of the liquid crystal panel 11 is transparent. The backlight 41 is constituted using a transparent light source and a transparent board. An organic EL (Electroluminescence) or an inorganic EL can be used as the transparent light source, for example. Alternatively, an almost transparent LED backlight can be constituted by arranging a large number of thin and small LEDs on a board made of glass, plastic, or the like. As a method for obtaining the transparent board, there are a method of making the board itself by a transparent material, a method of making the board as a thin film (for example, having a thickness not more than several nanometers) to allow light pass through the board, or the like. By using such a method, it is possible to constitute the direct type backlight 41, a part of which overlaps with the display area of the liquid crystal panel 11 is transparent. Also according the variant of the liquid crystal display device having the direct type backlight 41, the same effects as those attained by the first to seventh embodiments can be attained. When the direct type backlight 41 is used as the lighting unit, it is possible to show a space behind the display screen transparently, by making a part of the lighting unit transparent, the part overlapping with the display area of a display panel (liquid crystal panel 11).

### Eighth Embodiment

A liquid crystal display device according to an eighth embodiment of the present invention is obtained based on the liquid crystal display device according to the first embodiment by replacing the liquid crystal panel 11 and the backlight 12 with an absorption type polarizing plate 31, a liquid crystal panel 32, a backlight 33, and a reflection type polarizing plate 34 shown below. Differences from the first embodiment will be described below.

FIG. 21 is a diagram showing a cross section of a display unit of the liquid crystal display device according to the present embodiment. As shown in FIG. 21, the liquid crystal display device according to the present embodiment includes the absorption type polarizing plate 31, the liquid crystal panel 32, the backlight 33, and the reflection type polarizing plate 34. The liquid crystal panel 32 is obtained by removing the polarizing plates 21, 26 from the liquid crystal panel 11 according to the first embodiment.

The backlight 33 is obtained by adding a scatterer 35 to the backlight 12 according to the first embodiment. The scatterer 35 is provided on a surface of the light guide plate 18, the surface being on a side of the liquid crystal panel 32. The scatterer 35 scatters light having passed through the light guide plate 18 toward the reflection type polarizing plate 34. In this manner, the backlight 33 irradiates the reflection type polarizing plate 34 with light.

The absorption type polarizing plate 31 is disposed in front of the liquid crystal panel 32. The absorption type polarizing plate 31 allows a component polarized in a predetermined direction included in an incident light to pass through and absorbs a component polarized in a perpendicular direction thereof. The reflection type polarizing plate 34 is disposed in back of the backlight 33. The reflection type polarizing plate 34 allows a component polarized in a predetermined direction included in an incident light to pass through and reflects a component polarized in a perpendicular direction thereof. Y direction and z direction are determined as shown in FIG. 21, and a direction perpendicular to y direction and z direction is referred to as x direction (not shown). Hereinafter, it is assumed that the absorption type polarizing plate 31 and the reflection type polarizing plate 34 allow an x-direction polarization component included in the incident light to pass through.

A scanning line drive circuit and a data line drive circuit (not shown) write a data voltage to a pixel circuit in the liquid crystal panel 32. A polarizing direction of light incident to the liquid crystal panel 32 rotates in a range from 0° to 90° for each pixel circuit, in accordance with the data voltage written to the pixel circuit. Hereinafter, light incident from a back of the display screen is referred to as “first environment light”, light incident from a front of the display screen is referred to as “second environment light”, light emitted from the backlight 33 is referred to as “light from backlight”, and a rotation angle of polarization direction of incident light at the liquid crystal panel 32 is referred to as “rotation angle”. The first environment light, the second environment light, and the light from the backlight proceed in accordance with the rotation angle as described below.

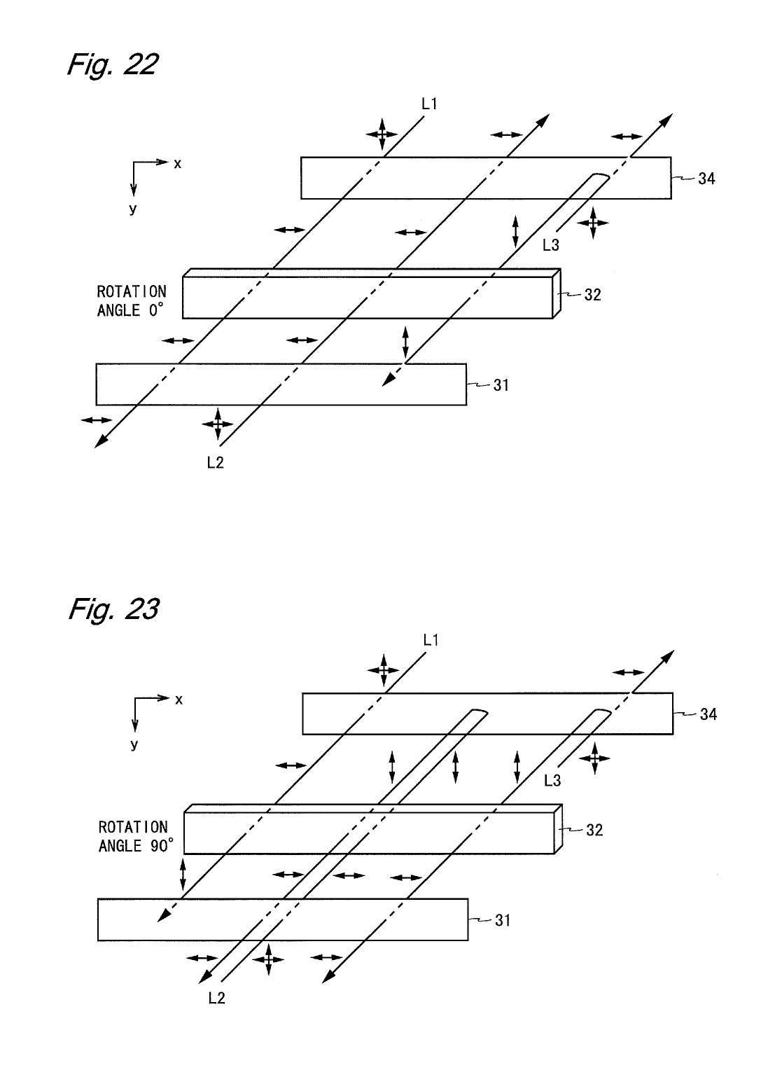

FIG. 22 is a diagram showing how light proceeds when the rotation angle is 0°. As shown in FIG. 22, only an x-direction polarization component of the first environment light L1 passes through the reflection type polarizing plate 34. Light having passed through the reflection type polarizing plate 34 passes through the liquid crystal panel 32 and the absorption type polarizing plate 31, and is emitted toward a front of the display screen. Only an x-direction polarization component of the second environment light L2 passes through the absorption type polarizing plate 31. Light having passed through the absorption type polarizing plate 31 passes through the liquid crystal panel 32 and the reflection type polarizing plate 34, and is not emitted toward the front of the display screen. Of the light from the backlight L3, an x-direction polarization component passes through the reflection type polarizing plate 34, and a y-direction polarization component reflects at the reflection type polarizing plate 34. Light reflected at the reflection type polarizing plate 34 is absorbed by the absorption type polarizing plate 31, and is not emitted toward the front of the display screen. In this manner, when the rotation angle is 0°, of the first environment light L1, the second environment light L2, and the light from the backlight L3, only the x-direction polarization component of the first environment light L1 is emitted toward the front of the display screen.

FIG. 23 is a diagram showing how light proceeds when the rotation angle is 90°. As shown in FIG. 23, only the x-direction polarization component of the first environment light L1 passes through the reflection type polarizing plate 34, and is incident to the liquid crystal panel 32. Since the liquid crystal panel 32 rotates a polarization direction of incident light by 90°, the polarization direction of the light having passed through the liquid crystal panel 32 becomes the y direction. Light having passed through the liquid crystal panel 32 is absorbed by the absorption type polarizing plate 31, and is not emitted toward the front of the display screen. Only the x-direction polarization component of the second environment light L2 passes through the absorption type polarizing plate 31, and is incident to the liquid crystal panel 32. By the action of the liquid crystal panel 32, the polarization direction of light having passed through the liquid crystal panel 32 becomes the y direction. Light having passed through the liquid crystal panel 32 reflects at the reflection type polarizing plate 34, and is incident to the liquid crystal panel 32 again. By the action of the liquid crystal panel 32, the polarization direction of light having passed through the liquid crystal panel 32 twice becomes the x direction. Light having passed through the liquid crystal panel 32 twice passes through the absorption type polarizing plate 31, and is emitted toward the front of the display screen. Of the light from the backlight L3, the x-direction polarization component passes through the reflection type polarizing plate 34, and the y-direction polarization component reflects at the reflection type polarizing plate 34 and is incident to the liquid crystal panel 32. By the action of the liquid crystal panel 32, the polarization direction of light having passed through the liquid crystal panel 32 becomes the x direction. Light having passed through the liquid crystal panel 32 passes through the absorption type polarizing plate 31, and is emitted toward the front of the display screen. In this manner, when the rotation angle is 90°, of the first environment light L1, the second environment light L2, and the light from the backlight L3, the x-direction polarization component of the second environment light L2 and the y-direction polarization component of the light from the backlight L3 are emitted toward the front of the display screen.

In the liquid crystal display device according to the present embodiment, when the rotation angle is 0°, a space behind the display screen can be seen transparently in the display screen. When the rotation angle is 90° and the backlight 33 is turned off, a space in front of the display screen can be seen reflectively like a mirror in the display screen. When the rotation angle is 90° and the backlight 33 is turned on, the display screen appears white by the light from the backlight.

The backlight control information is supplied to the liquid crystal display device according to the present embodiment, by a method similar to those in the first to fourth embodiments. Specifically, in the liquid crystal display device according to the present embodiment, the backlight control information is included in the part of the video signal V1 for one frame period corresponding to the blanking period, in one of a format similar to those in the first to fourth embodiments.

Alternatively, as a variant of the present embodiment, it is possible to constitute a field-sequential type liquid crystal display device. To the liquid crystal display device according to the variant of the present embodiment, the backlight control information is supplied by a method similar to those in the fifth to seventh embodiments. Specifically, in the liquid crystal display device according to the variant of the present embodiment, the backlight control information is included in the part of the video signal V1 for one field period corresponding to the blanking period, in one of a format similar to those in the fifth to seventh embodiments.

As shown above, the liquid crystal display device according to the present embodiment includes a display panel, a lighting unit, the absorption type polarizing plate 31 disposed in front of the display panel, and the reflection type polarizing plate 34 disposed in back of the lighting unit. The display panel is the liquid crystal panel 32, and the lighting unit is the backlight 33 for emitting light toward the reflection type polarizing plate 34. According to the liquid crystal display device of the present embodiment, as with the first to seventh embodiments, it is possible to easily receive the lighting control information (backlight control information) without reducing an amount of the video data, and change contents displayed in the display screen based on the lighting control information.

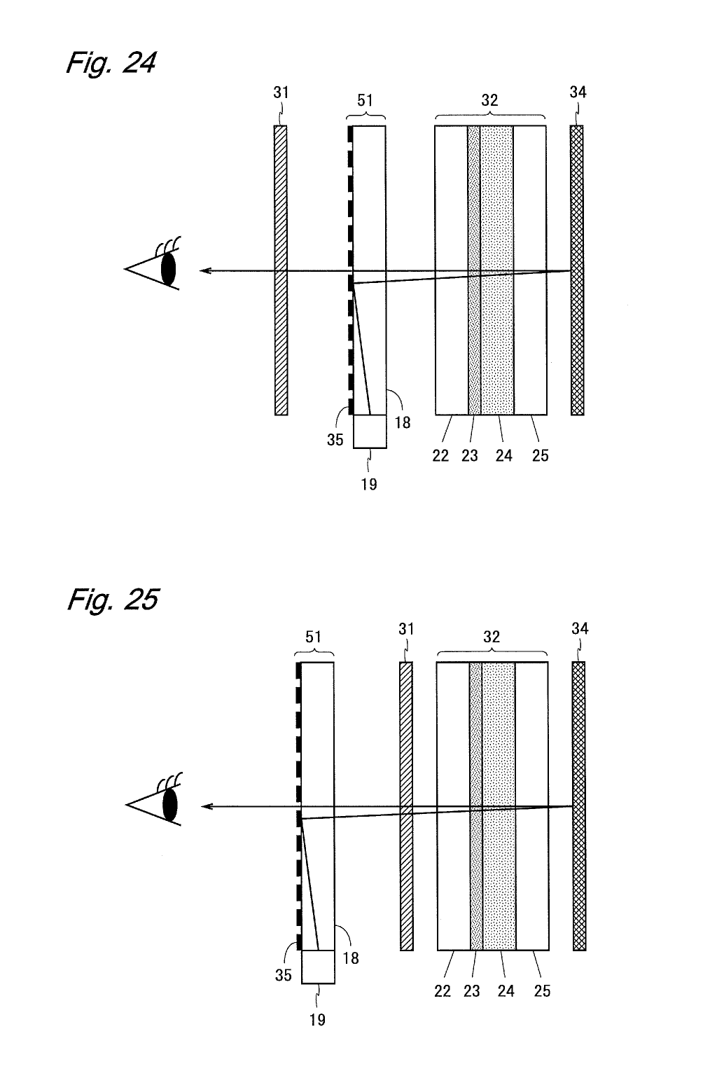

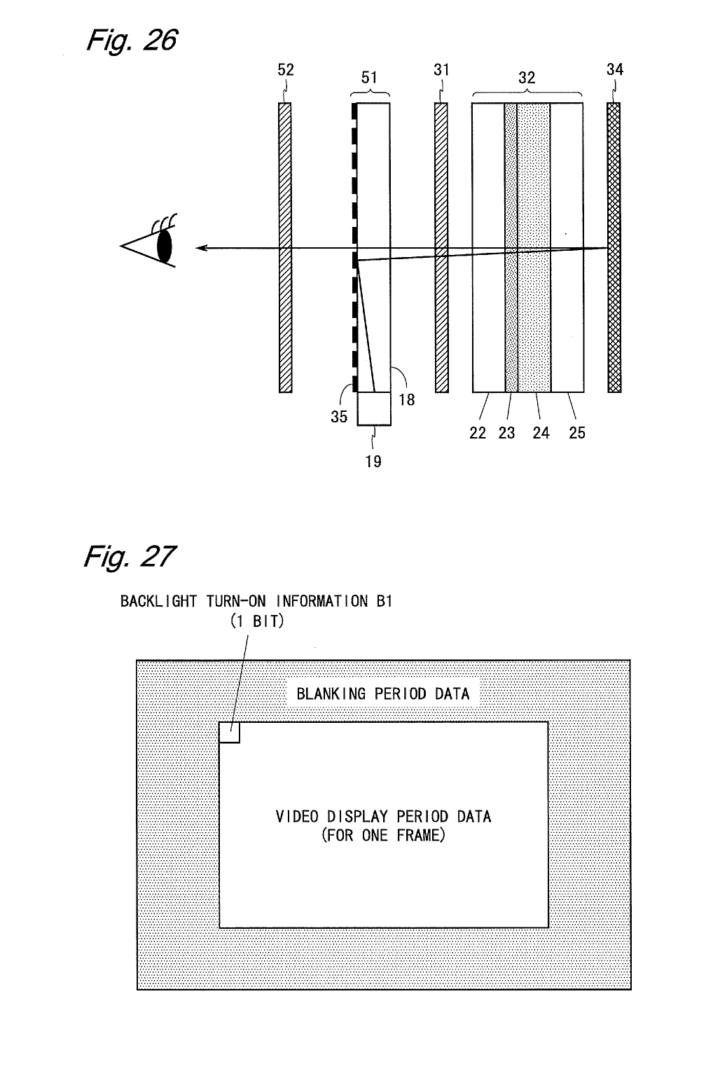

Note that as a variant of the eighth embodiment, a liquid crystal display device including a front light in place of the edge light type backlight 33 may be constituted. FIGS. 24 to 26 are diagrams showing cross sections of display units of liquid crystal display devices of the variants of the eighth embodiment of the present invention. Each of the liquid crystal display devices shown in FIGS. 24 to 26 includes the liquid crystal panel 32 as a display panel and a front light 51 as a lighting unit. The liquid crystal display device shown in FIG. 24 includes the absorption type polarizing plate 31 disposed in front of the front light 51, and the reflection type polarizing plate 34 disposed in back of the liquid crystal panel 32. The front light 51 has the same configuration as the backlight 33, and is disposed in front of the liquid crystal panel 32. The front light 51 irradiates a front surface of the liquid crystal panel 32 with light. The liquid crystal display device shown in FIG. 25 includes the absorption type polarizing plate 31 disposed in front of the liquid crystal panel 32, and the reflection type polarizing plate 34 disposed in back of the liquid crystal panel 32. The front light 51 irradiates the absorption type polarizing plate 31 with light. The liquid crystal display device shown in FIG. 26 is obtained by adding a leakage-suppressing absorption type polarizing plate 52 to the liquid crystal display device shown in FIG. 25. The leakage-suppressing absorption type polarizing plate 52 is disposed in front of the front light 51. According to the liquid crystal display devices of the variants of the eighth embodiment including the front light 51, the same effects as those attained by the eighth embodiment can be attained. According to the liquid crystal display device shown in FIG. 26, it is possible to absorb a part of light leaked from the front light 51 toward the front using the leakage-suppressing absorption type polarizing plate 52, and prevent image quality degradation due to leakage of light from the front light.

### Ninth Embodiment

A liquid crystal display device according to a ninth embodiment of the present invention is a color-filter type liquid crystal display device having the same configuration as the liquid crystal display device according to the first embodiment. In the liquid crystal display device according to the present embodiment, the backlight control information is included in a position which is different from those in the first to fourth embodiments. Differences from the first to fourth embodiments will be described below.

FIG. 27 is a diagram showing a first example of a format of the video signal V1 according to the present embodiment. In FIG. 27, the backlight turn-on information B1 having one bit is included in the part of the video signal V1 corresponding to the video display period. The backlight turn-on information B1 is included in a position of video data of a pixel in an upper left corner (hereinafter referred to as upper-left corner pixel) in the display screen.

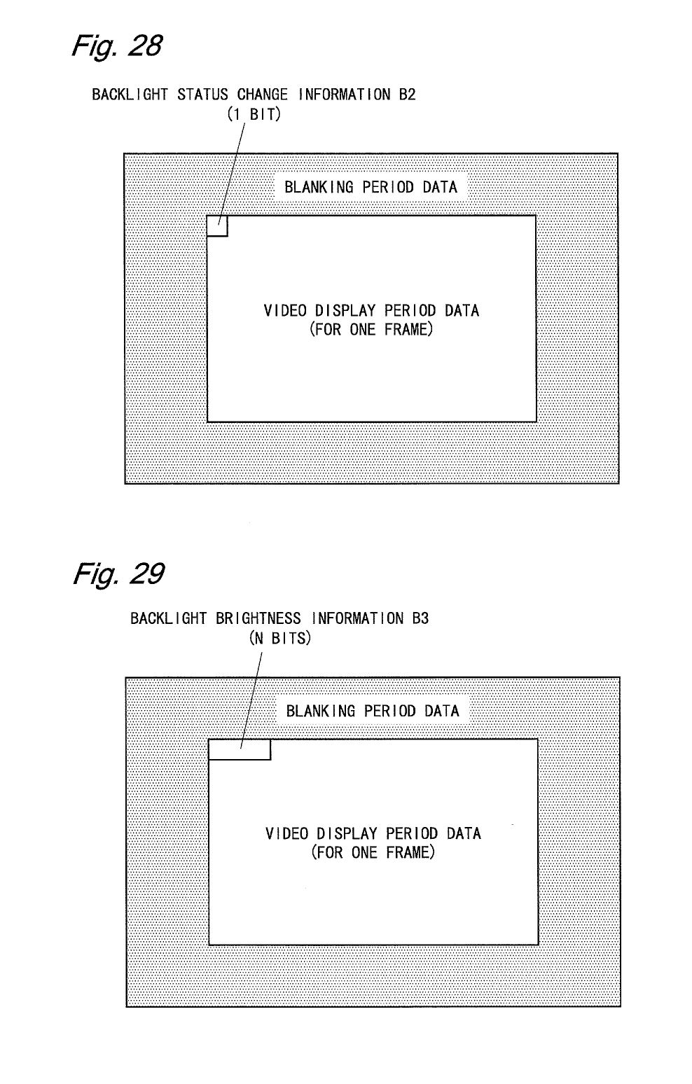

FIG. 28 is a diagram showing a second example of the format of the video signal V1 according to the present embodiment. In FIG. 28, the backlight status change information B2 having one bit is included in the part of the video signal V1 corresponding to the video display period. The backlight status change information B2 is included in the position of the video data of the upper-left corner pixel.

FIG. 29 is a diagram showing a third example of the format of the video signal V1 according to the present embodiment. In FIG. 29, the backlight brightness information B3 having N bits is included in the part of the video signal V1 corresponding to the video display period. The backlight brightness information B3 is included in the position of the video data of the upper-left corner pixel.

In these cases, the display control circuit 13 knows the position of the backlight control information. The display control circuit 13 can easily extract the backlight control information from the video signal V1.

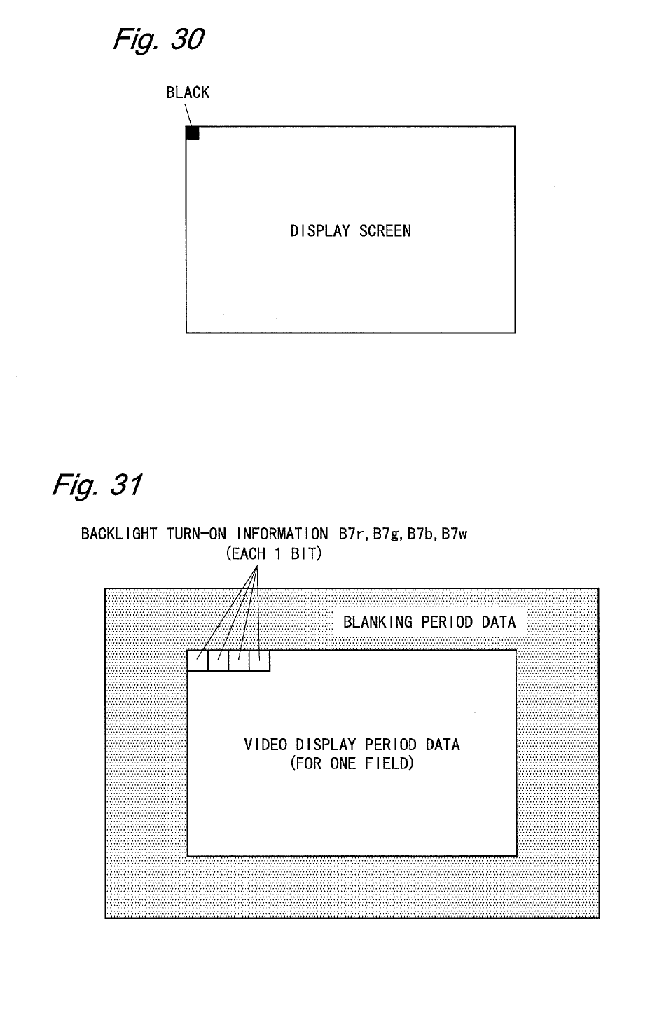

The video signal V1 according to the present embodiment does not include the video data of the upper-left corner pixel. The drive circuit of the liquid crystal display device according to the present embodiment drives the liquid crystal panel 11 using a fixed color data (for example, data corresponding to black) in place of the video data of the upper-left corner pixel. Therefore, the color of the upper-left corner pixel is the fixed color (for example, black) in the display screen (refer to FIG. 30).

As shown above, in the liquid crystal display device according to the present embodiment, the lighting control information (backlight control information) is included in the part of the video signal V1 corresponding to the video display period. Therefore, according to the liquid crystal display device of the present embodiment, it is possible to easily receive the lighting control information and change the contents displayed in the display screen based on the lighting control information. Furthermore, the drive circuit of the liquid crystal display device according to the present embodiment drives a display panel (liquid crystal panel 11) using the fixed color data in place of the video data (video data of the upper-left corner pixel) which is missed from the video signal V1 due to the lighting control information.

Therefore, a natural image can be displayed.

Note that in the liquid crystal display device according to the present embodiment, the position of the backlight control information may be arbitrary, so long as it is included in the part of the video signal V1 corresponding to the video display period. However, considering effects on the display screen, it is preferable that the backlight control information be contained in the position of the video data of a pixel placed on an edge or in a corner of the display screen.

### Tenth Embodiment

A liquid crystal display device according to a tenth embodiment of the present invention is a field-sequential type liquid crystal display device having the same configuration as the liquid crystal display device according to the fifth embodiment. In the liquid crystal display device according to the present embodiment, backlight control information which is different from those of the fifth to seventh embodiments is included in a part of the video signal V1 corresponding to the video display period.

FIG. 31 is a diagram showing a first example of a format of the video signal V1 according to the present embodiment. In FIG. 31, backlight turn-on information B7r, B7g, B7b, B7w each having one bit is included in the part of the video signal V1 for one field period corresponding to the video display period. The backlight color information B7r, B7g, B7b, B7w is included in a position of the video data of the upper-left corner pixel.

The backlight 12 of the liquid crystal display device according to the present embodiment includes a red light source, a green light source, a blue light sources, and a white light source. The backlight turn-on information B7r indicates whether the red light source is to be turned on. The backlight turn-on information B7g indicates whether the green light source is to be turned on. The backlight turn-on information B7b indicates whether the blue light source is to be turned on. The backlight turn-on information B7w indicates whether the white light source is to be turned on. The drive circuit of the liquid crystal display device according to the present embodiment drives the liquid crystal panel 11 using the fixed color data (for example, data corresponding to black) in place of the video data of the upper-left corner pixel.

According to the liquid crystal display device of the present embodiment, a turn-on status of light sources included in the backlight 12 can be controlled easily in each field.

In FIG. 31, the backlight turn-on information B7r, B7g, B7b, B7w concerning the light sources corresponding to four colors of red, green, blue, and white is included in the part of the video signal V1 for one field period corresponding to the video display period. In place of this, backlight turn-on information concerning light sources corresponding to other colors or light sources corresponding to not less than five colors may be included in the part the video signal V1 for one field period corresponding to the video display period.

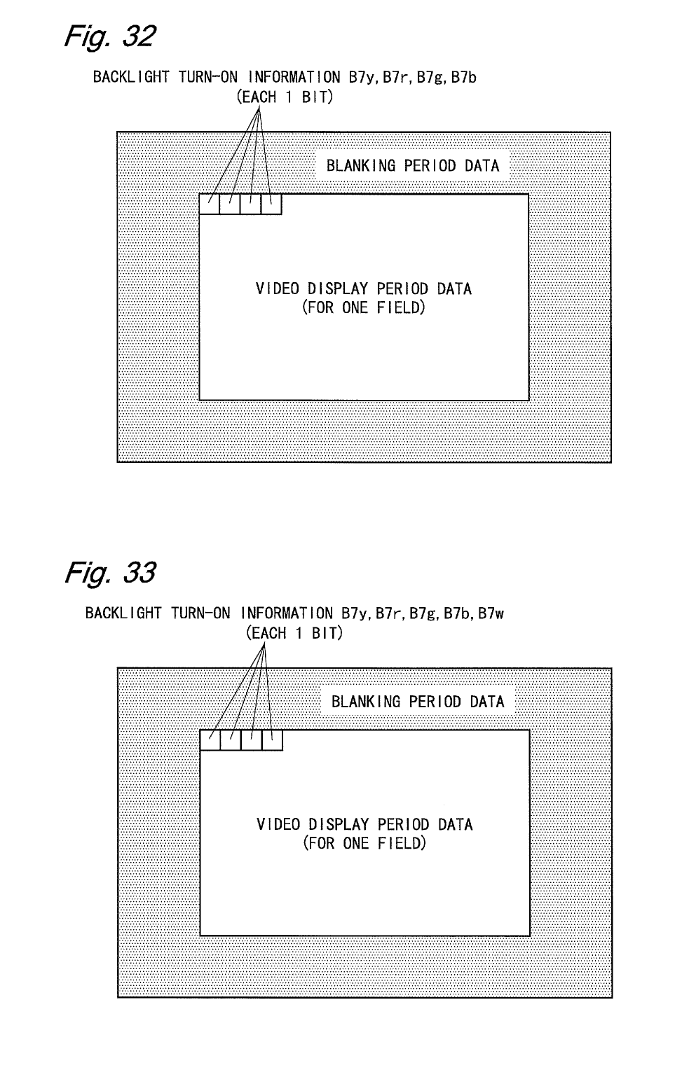

FIGS. 32 and 33 are diagrams showing second and third examples of the format of the video signal V1 according to the present embodiment, respectively. As shown in FIG. 32, the backlight turn-on information B7y, B7r, B7g, B7b concerning light sources corresponding to four colors of yellow, red, green, and blue may be included in the part of the video signal V1 for one field period corresponding to the video display period. As shown in FIG. 33, the backlight turn-on information B7y, B7r, B7g, B7b, B7w concerning light sources corresponding to five colors of yellow, red, green, blue, and white may be included in the part of the video signal V1 for one field period corresponding to the video display period.

### Eleventh Embodiment

A liquid crystal display device according to an eleventh embodiment of the present invention is either a color-filter type liquid crystal display device having the same configuration as the first embodiment and a field-sequential type liquid crystal display device having the same configuration as the fifth embodiment. The video signal V1 according to the present embodiment has a format shown in one of FIGS. 27 to 29 and FIGS. 31 to 33.

The video signal V1 according to the present embodiment does not include the video data for the upper-left corner pixel.

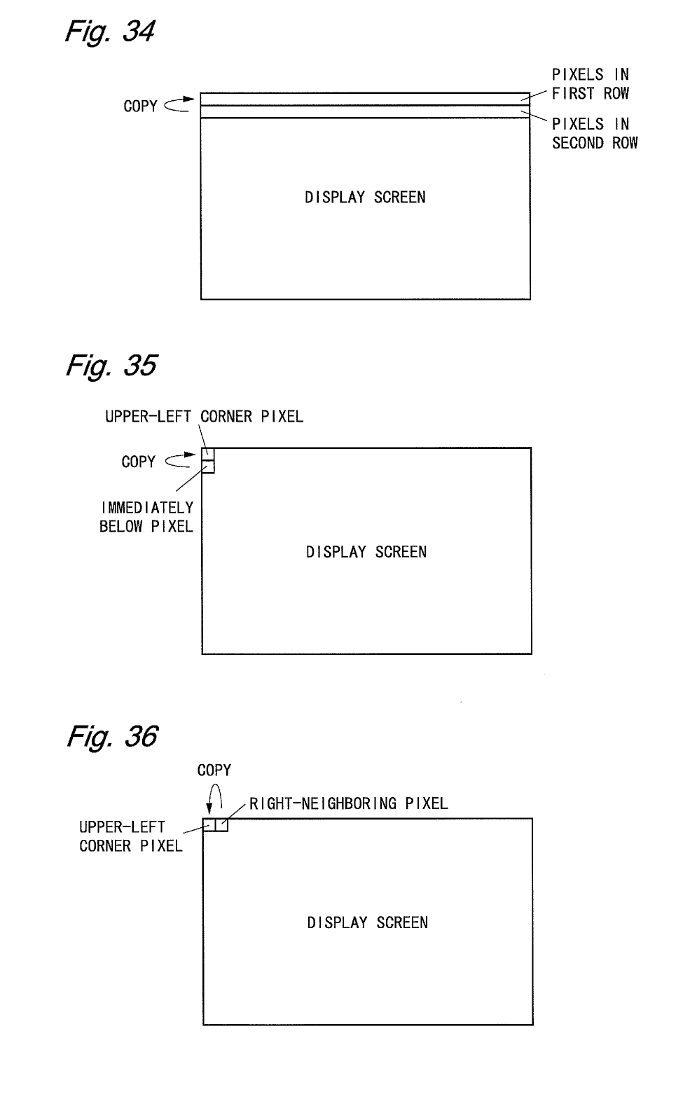

The drive circuit of the liquid crystal display device according to the present embodiment drives the liquid crystal panel 11 using the video data of pixels in a second line, in place of the video data of the pixels in a first line. Therefore, in the display screen, display contents of the pixels in the second line is copied to the first line, and the color of each pixel in the first line is the same as that of a pixel in the second line (refer to FIG. 34).

Alternatively, the drive circuit of the liquid crystal display device according to the present embodiment may drive the liquid crystal panel 11 using, in place of the video data of the upper-left corner pixel, the video data of immediately below pixel (pixel in second row and first column). In this case, display contents of the immediately below pixel is copied to the upper-left corner pixel in the display screen, and the color of the upper-left corner pixel is the same as that of the immediately below pixel (refer to FIG. 35).

Alternatively, the drive circuit of the liquid crystal display device according to the present embodiment may drive the liquid crystal panel 11 using, in place of the video data of the upper-left corner pixel, the video data of a right-neighboring pixel (pixel in first row and second column). In this case, display contents of the right-neighboring pixel is copied to the upper-left corner pixel in the display screen, and the color of the upper-left corner pixel is the same as that of the right-neighboring pixel (refer to FIG. 36).

As shown above, in the liquid crystal display device according to the present embodiment, the lighting control information (backlight control information) is included in the part of the video signal V1 corresponding to the video display period. The drive circuit drives a display panel (liquid crystal panel 11) using data of a neighboring pixel in place of the video data (video data of the upper-left corner pixel) which is missed from the video signal V1 due to the lighting control information. Therefore, a natural image can be displayed.

### Twelfth Embodiment

In the first to eleventh embodiments, the liquid crystal display devices having a function of showing a space behind a display screen transparently have been described. The present invention can be applied to various types of display devices, each of which includes a backlight which is not a single white color backlight and does not have the function of showing the space behind the display screen transparently. The display devices to which the present invention can be applied include a color-filter type liquid crystal display device, a field-sequential type liquid crystal display device, and a projector having a liquid crystal panel. The present invention can also be applied to a display device which includes a display panel having a plurality of shutter elements arranged two-dimensionally and having an on-state in which light passes through and an off-state in which light is prevented from passing, and a backlight, and switches the on-state and the off-state of the shutter elements in accordance with each bit of the video data, a plurality of times in one frame period.

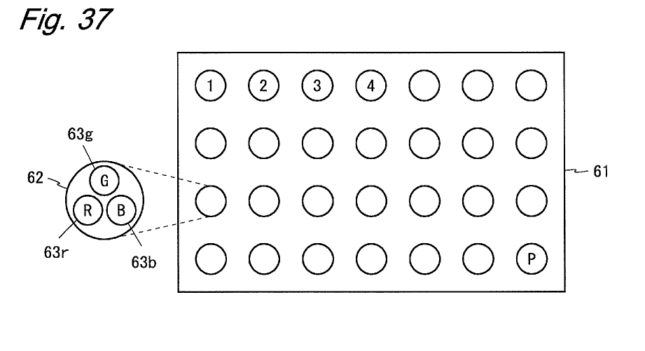

Here, as an example for a display device to which the present invention is applied, a liquid crystal display device which includes a backlight having red light sources, green light sources, and blue light sources and performs a local dimming processing will be described. This liquid crystal display device has a configuration in which the backlight 12 in the liquid crystal display device 10 (FIG. 1) according to the first embodiment is replaced with a backlight 61 shown in FIG. 37. The backlight 61 is not formed of a transparent material, and the liquid crystal display device does not have the function of showing a space behind a display screen transparently.

FIG. 37 is a diagram showing a configuration of a backlight of a liquid crystal display device performing the local dimming processing. The backlight 61 shown in FIG. 37 is a direct-type backlight including P light sources units 62 (P is an integer not less than 4) arranged two-dimensionally. The light source unit 62 includes a red light source 63r, a green light source 63g, and a blue light source 63b. The display screen is divided into P areas corresponding to the P light source units 62. Outside of the liquid crystal display device, the brightness of the red light source 63r, the green light source 63g, and the blue light source 63b are obtained based on the video signal V1 for each of the P light source units 62. The video signal V1 supplied to the liquid crystal display device includes the brightness of the red light sources 63r, the green light sources 63g, and the blue light sources 63b included in the P light source units 62.

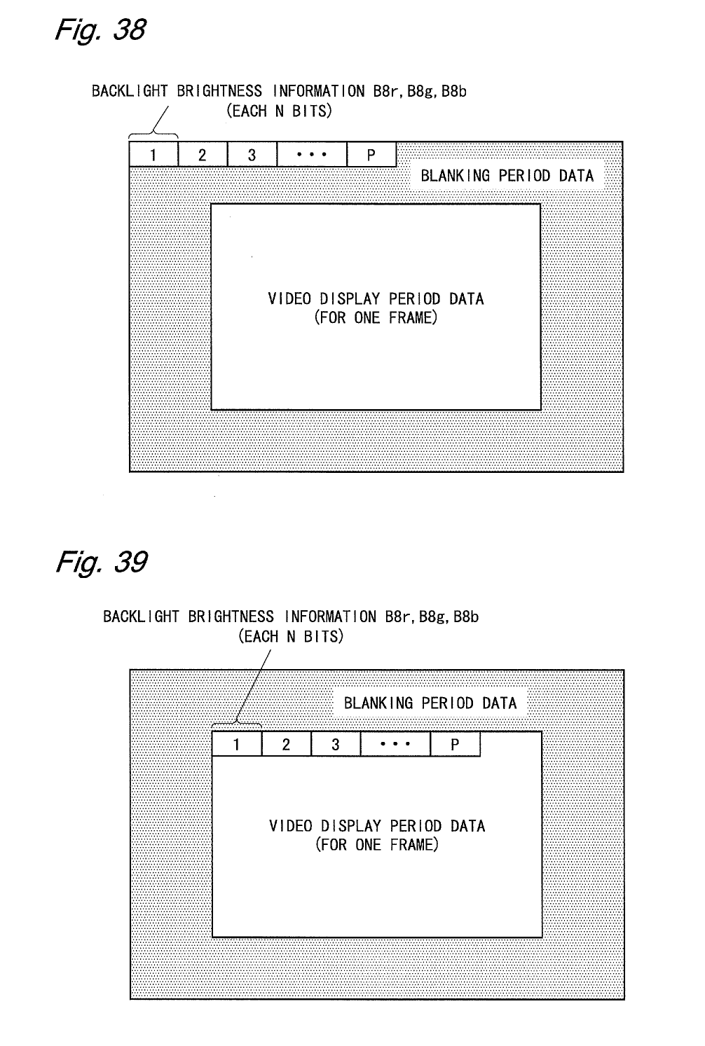

FIG. 38 is a diagram showing a first example of the video signal V1 supplied to the liquid crystal display device. In the first example, P light source unit control information is included in the part of the video signal V1 corresponding to the blanking period, as the backlight control information. The light source unit control information includes backlight brightness information B8r, B8g, B8b each having N bits. I-th backlight brightness information B8r, B8g, B8b (i is an integer not less than 1 and not more than P) represents the brightness of the red light source 63r, the green light source 63g, and the blue light source 63b included in an i-th light source unit 62, respectively, in 2^{N} levels.

FIG. 39 is a diagram showing a second example of the video signal V1 supplied to the liquid crystal display device. In the second example, P light source unit control information is included in the part of the video signal V1 corresponding to the video display period, as the backlight control information. Details of the light source unit control information are the same as those of the first example.

The liquid crystal display device performing the local dimming processing may include an edge light type backlight in place of the direct-type backlight 61 shown in FIG. 37. The edge light type backlight is constituted, for example, by arranging a plurality of the light source units 62 one-dimensionally along one side of a light guide plate.

As shown above, the liquid crystal display device according to the present embodiment includes a display panel (liquid crystal panel 11), a lighting unit (backlight 61) for irradiating one surface (back surface) of the display panel with light, a drive circuit (scanning line drive circuit 14, data line drive circuit 15, and backlight drive circuit 16) for driving the display panel and the lighting unit based on the video signal V1 supplied from the signal source 5. The lighting unit includes plural kinds of light sources (red light source 63r, green light source 63g, and blue light source 63b) corresponding to the different colors, a plurality of the light sources provided for each kind. The video signal V1 includes lighting control information (backlight brightness information B8r, B8g, B8b) indicating the brightness of the light sources 63 individually. The drive circuit controls the brightness of the light sources 63 individually, based on the lighting control information included in the video signal V1. The lighting control information is included in the part of the video signal corresponding to the blanking period or the part of the video signal corresponding to the video display period.

According to the display device of the present embodiment, in the display device including the lighting unit having the plural kinds of the light sources corresponding to the different colors, the plurality of the light sources provided for each kind, since the lighting control information is included in the video signal, it is possible to easily receive the lighting control information which indicates the brightness of the plurality kinds of the light sources individually.

Furthermore, power consumption of the display device can be reduced by individually controlling the brightness of the light sources based on the lighting control information. Especially, when the lighting control information is included in the part of the video signal corresponding to the blanking period, it is possible to easily receive the lighting control information without reducing an amount of the video data.

Display devices to which the present invention can be applied (including the display devices described above) will be described below. The present invention can be applied to various types of liquid crystal display devices, each including a backlight and having a function of showing a space behind a display screen transparently. The present invention can be applied to liquid crystal display devices (first to fourth and ninth embodiments), each including a liquid crystal panel with a color filter and a backlight for irradiating a back surface of the liquid crystal panel with white light, liquid crystal display devices (fifth to seventh and tenth embodiments) each including a liquid crystal panel without a color filter, and a backlight having plural kinds of light sources corresponding to different colors, wherein one kind of the light source in accordance with a field period is turned on. Furthermore, the present invention can be applied to liquid crystal display devices (first to seventh, ninth and tenth embodiments) each including a backlight for emitting light toward a front, and a liquid crystal display device (eighth embodiment) including a backlight for emitting light toward a back. Furthermore, the present invention can be applied to liquid crystal display devices (first to tenth embodiments) for writing, to each pixel circuit of a liquid crystal panel, a data voltage in accordance with a video data having k bits (k is an integer not less than 2) once in one frame period (or one field period), and a liquid crystal display device for writing, to each pixel circuit of a liquid crystal panel, one of a high level voltage and a low level voltage k times in one frame period (or one field period) in accordance with each bit of k bit video data. In these liquid crystal display devices, the backlight control information can be received easily without increasing the number of signal lines, by placing the backlight control information in the video signal. Furthermore, the contents displayed in the display screen (especially, in the transparent area in the display screen) can be switched by controlling the status or the brightness of the backlight based on the backlight control information. Furthermore, the backlight control information can be received without reducing an amount of the video data, by placing the backlight control information in the part of the video signal corresponding to the blanking period.

Furthermore, the present invention can be applied to other display devices (display device other than the liquid crystal display device), each including a lighting unit for irradiating one surface of a display panel with light, and having a function of showing a space behind a display screen transparently. For example, the present invention can be applied to a display device including a display panel having a plurality of shutter elements arranged two-dimensionally and having an on-state in which light passes through and an off-state in which light is prevented from passing through, and a backlight, the display device configured to switch the shutter elements between the on-state and the off-state in accordance with each bit of the video data, a plurality of times in one frame period. Furthermore, the present invention can be applied to various types of display devices, each including a lighting unit having plural kinds of light sources corresponding to different colors and not having the function of showing the space behind the display screen transparently.

Furthermore, by combining features of the above-described display devices, unless contrary to the natures thereof, it is possible to constitute a display device having features of a plurality of embodiments or variants.

### INDUSTRIAL APPLICABILITY

Since the display device according to the present invention has a feature that the lighting control information can be received easily, the display device can be used as a stand-alone display device, or can be used as a display unit of various electrical equipments, or the like.

### DESCRIPTION OF REFERENCE CHARACTERS

10: LIQUID CRYSTAL DISPLAY DEVICE
11, 32: LIQUID CRYSTAL PANEL
12, 33, 41, 61: BACKLIGHT
13: DISPLAY CONTROL CIRCUIT
14: SCANNING LINE DRIVE CIRCUIT
15: DATA LINE DRIVE CIRCUIT
16: BACKLIGHT DRIVE CIRCUIT
17: PIXEL CIRCUIT
18: LIGHT GUIDE PLATE
19, 63: LIGHT SOURCE
21, 26: POLARIZING PLATE
22, 25: GLASS SUBSTRATE
23: COLOR FILTER
24: LIQUID CRYSTAL
31: ABSORPTION TYPE POLARIZING PLATE
34: REFLECTION TYPE POLARIZING PLATE
35: SCATTERER
51: FRONT LIGHT
52: LEAKAGE-SUPPRESSING ABSORPTION TYPE POLARIZING PLATE
62: LIGHT SOURCE UNIT

1. A display device having a function of showing a space behind a display screen transparently, the device comprising:
a display panel;
a lighting unit configured to irradiate one surface of the display panel with light; and
a drive circuit configured to drive the display panel and the lighting unit based on a video signal supplied from a signal source, wherein
a part of the lighting unit that overlaps with a display area of the display panel is transparent,
the video signal includes lighting control information, and
the drive circuit is configured to drive the lighting unit based on the lighting control information included in the video signal.

2. The display device according to claim 1, wherein the lighting control information is included in a part of the video signal corresponding to a blanking period.

3. The display device according to claim 1, wherein the lighting control information is included in a part of the video signal corresponding to a video display period.

4. The display device according to claim 1, wherein
the lighting control information includes lighting turn-on information indicating whether the lighting unit is to be turned on, and
the drive circuit is configured to switch whether the lighting unit is turned on, based on the lighting turn-on information.

5. The display device according to claim 1, wherein
the lighting control information includes lighting status change information indicating to change a status of the lighting unit, and
the drive circuit is configured to change the status of the lighting unit from turn-on to turn-off or from turn-off to turn-on, based on the lighting status change information.

6. The display device according to claim 1, wherein
the lighting control information includes lighting brightness information indicating brightness of the lighting unit, and
the drive circuit is configured to control the brightness of the lighting unit based on the lighting brightness information.

7. The display device according to claim 1, wherein
the display panel is a liquid crystal panel with a color filter,
the lighting unit is a backlight configured to irradiate a back surface of the display panel with white light,
a part of the video signal corresponding to a video display period includes video data for one frame, and
the drive circuit is configured to drive the display panel based on the video data in each frame period.

8. The display device according to claim 1, wherein
the display panel is a liquid crystal panel without a color filter,
the lighting unit is a backlight including plural kinds of light sources corresponding to different colors,
a part of the video signal corresponding to a video display period includes video data for one field, and
the drive circuit is configured to drive the display panel based on the video data in each field period and control one kind of the light source to turn on in each field period, the kind in accordance with the field period.

9. The display device according to claim 8, wherein
the lighting control information includes lighting color information indicating a color of a field, and
the drive circuit is configured to control one kind of the light source to turn on, the kind corresponding to the color indicated by the lighting color information.

10. The display device according to claim 8, wherein
the lighting control information includes lighting brightness information indicating brightness of the plural kinds of the light sources, and
the drive circuit is configured to control the brightness of the plural kinds of the light sources based on the lighting brightness information.

11. The display device according to claim 2, wherein a position of the lighting control information is fixed in the part of the video signal corresponding to the blanking period.

12. The display device according to claim 2, wherein
a position of the lighting control information is not fixed in the part of the video signal corresponding to the blanking period, and
the drive circuit is configured to search the lighting control information in the part of the video signal corresponding to the blanking period.

13. The display device according to claim 3, wherein the drive circuit is configured to drive the display panel using a fixed color data in place of video data which is missed from the video signal due to the lighting control information.

14. The display device according to claim 3, wherein the drive circuit is configured to drive the display panel using video data of a neighboring pixel in place of video data which is missed from the video signal due to the lighting control information.

15-16. (canceled)

17. The display device according to claim 1, further comprising:
an absorption type polarizing plate disposed in front of the display panel; and
a reflection type polarizing plate disposed in back of the lighting unit, wherein
the display panel is a liquid crystal panel, and
the lighting unit is a backlight configured to emit light toward the reflection type polarizing plate.

18. The display device according to claim 1, further comprising:
an absorption type polarizing plate; and
a reflection type polarizing plate disposed in back of the display panel, wherein
the display panel is a liquid crystal panel,
the lighting unit is a front light configured to emit light toward a front surface of the display panel, and
the absorption type polarizing plate is disposed in front of the lighting unit.

19. The display device according to claim 1, further comprising:
an absorption type polarizing plate disposed in front of the display panel; and
a reflection type polarizing plate disposed in back of the display panel, wherein
the display panel is a liquid crystal panel, and
the lighting unit is a front light configured to emit light toward the absorption type polarizing plate.

20. The display device according to claim 19, further comprising a leakage-suppressing absorption type polarizing plate disposed in front of the lighting unit.

21. A display device comprising:
a display panel;
a lighting unit configured to irradiate one surface of the display panel with light; and
a drive circuit configured to drive the display panel and the lighting unit based on a video signal supplied from a signal source, wherein
the lighting unit includes plural kinds of light sources corresponding to different colors, a plurality of the light sources provided for each kind,
the video signal includes lighting control information indicating brightness of the light sources individually, and
the drive circuit is configured to control the brightness of the light sources individually, based on the lighting control information included in the video signal.

22. The display device according to claim 21, wherein the lighting control information is included in a part of the video signal corresponding to one of a blanking period and a video display period.

23. (canceled)
